(19) United States
(12) Patent Application Publication
(10) Pub. No.: US 2025/0367574 A1
(43) Pub. Date: Dec. 4, 2025

(54) AUTOMATED METHOD AND DEVICE FOR PRODUCTION OF LEAD 212 FOR USE IN TARGETED ALPHA-PARTICLE THERAPY

(71) Applicant: RADIOMEDIX, INC., Houston, TX (US)

(72) Inventors: Ebrahim Delpassand, Houston, TX (US); Izabela Tworowska, Houston, TX (US); Jared Jaksik, Conroe, TX (US); Yongjun Yan, Houston, TX (US)

(21) Appl. No.: 19/235,565

(22) Filed: Jun. 11, 2025

Related U.S. Application Data
(63) Continuation-in-part of application No. 18/623,611, filed on Apr. 1, 2024.
(60) Provisional application No. 63/493,139, filed on Mar. 30, 2023.

(51) Int. Cl. B01D 15/18; B01D 15/22; B01D 15/36; B01D 15/42; C22B 3/00; C22B 3/02; C22B 3/42; G21F 5/12

(52) U.S. Cl. CPC B01D 15/1871; B01D 15/222; B01D 15/362; B01D 15/363; B01D 15/424; C22B 3/02; C22B 3/42; C22B 13/04; G21F 5/12

(57) ABSTRACT

The present disclosure relates to an automated device and methods to produce a highly purified α-emitting radioisotope Pb-212 from a pre-filled column of a parent isotope Ra-224 for use in targeted α-particle therapy.

### CROSS-REFERENCE TO RELATED APPLICATION

This application claims priority to U.S. Non-Provisional application Ser. No. 18/623,611 filed on Apr. 1, 2024, and U.S. Provisional Application No. 63/493,139 filed on Mar. 30, 2023, which is hereby incorporated by reference in its entirety.

### FIELD OF THE INVENTION

The present disclosure relates to an automated device to produce highly purified α-emitting radioisotope Pb-212 from a pre-filled column of a parent isotope Ra-224 for use in targeted α-particle therapy.

### BACKGROUND OF THE INVENTION

Receptor-targeted cancer treatment remains a growing field of interest as research focuses on selectively delivering targeted treatment methods to tumors by chelation of small molecules that identify tumor-associated receptors, metabolic pathways, transporters, and antigens. These small molecules may include purified radioisotopes, which utilize a high-energy emission to powerfully target and destroy cancerous cells. The ability to diagnose certain cancers and damage the cancerous cells with limited effect on surrounding healthy tissue is a desirable mechanism with the potential to significantly advance an individual's treatment while minimizing toxic side-effects.

Therefore, targeted radionuclide therapy (TRT) has become an attractive and quickly developing therapy option for many diseases, including various types of cancers. While much research in the past has focused on beta-emitting particles, another form of targeted radionuclide therapy includes targeted α-particle therapy (TAT), which is a growing field directed to a method of purifying radioactive substances through α decay for use in targeting cancerous tissues with a high degree of specificity. α-emitting-particles are advantageous over β-emitting particles due to the high energy and short path length of the α particles. Furthermore, certain cancer tissues may be resistant to β-emitters and patients may suffer a number of side effects, giving α-emitting-particles a distinct advantage in targeted therapeutics.

In the art, various methods for producing and purifying radioisotopes have been found to show great potential in TRT and TAT treatments, and in particular Pb-212 has shown promise in the development of new therapies that target cancer cells while minimizing impact on healthy tissue. Early studies into Pb-212 as an α-emitting radionuclide showed increased efficiency in killing human ovarian cancer cells compared to x-ray therapy. Pb-212 has been the focus of several clinical trials, including a phase I clinical trial with Pb-212-TCMC-trastuzumab at the University of Alabama, Birmingham, showing minimal toxicity levels when used to treat ovarian cancer. Recently, first-in-Humans Dose-Escalation Clinical Trial using Targeted Alpha-emitter Therapy (TAT) with Pb-212-DOTAMTATE for the Treatment of Metastatic SSTR-Expressing Neuroendocrine Tumors revealed that α-therapy with Pb-212-DOTAMTATE to be well tolerated and efficacious. A phase II trial for the use of Pb-212-DOTAMTATE in TAT treatments of patients with somatostatin receptor-expressing neuroendocrine tumors (NET) is ongoing.

Pb-212 is a daughter product of the Th-228 radioactive family. Th-228 has a half-life of about 1.9 years. Ra-224 falls within the same radioactive decay chain and has been used as a generator to obtain continuous amounts of Pb-212 through radioactive decay. Typically, the generator is a device containing the Ra-224 bound to an exchange resin, and the Pb-212 is recovered by elution. The Pb-212 containing eluate undergoes acid digestion to remove chemical impurities.

Various deficiencies exist with current methods of purifying and using such purified Pb-212, including potential accumulation of the radioactive isotope in the patient's bone marrow and other side-effects resulting from the natural toxicity of any accrued free lead. Current methods provide only low levels of purification and consequently require low dosages of the therapeutic drugs to avoid unintended and dangerous side-effects. Due to the impact of potential toxicity, there is a significant disadvantage to using less purified radioisotopes in TAT treatments.

Thus, there is an unmet need for improved processes for generating Pb-212, i.e., to reduce the impact of impurities and radioisotope toxicity. There also exists a clinical need for efficient processes for generating purified Pb-212 for improved and effective targeted α-particle therapy.

The present invention provides methods for improved Pb-212 synthesis, purification, and use. The invention includes automated synthesis, improved purification systems for Targeted α-particle Therapy employing cassette based automated synthesis module, purification resins, higher activities of the isotopes, and radiation shielding of columns containing the isotopes. The invention leads to a more streamlined process of producing a emitter treatments that provide advantages of previous methods of treatment but with increased purity, ultimately causing lower rates of toxicity in patients receiving the final radiopharmaceuticals labeled with Pb-212. The processes of this invention allow for higher activities of reagents and products, and facilitate scale-up and commercial manufacturing of Pb-212. In addition, the invention provides more effective radiation shielding for improved operator, and public safety and ease of transportation during shipping.

Generally, 224Ra/212Pb generators are chromatography columns filled with cation-exchange resin as activity adsorption media (e.g., Bio-Rad's AG MP-50) where 224Ra activity is loaded and adsorbed onto the resin. Due to the radiation damage of resin by α particles, only a small amount of 224Ra activity can be loaded directly onto the resin by passing a 224Ra solution through the column. In the case where 224Ra is loaded directly onto the column by afferent flow, the majority of the activity becomes concentrated at the top of the column's bed volume, where α-particle driven radiation damage occurs and negatively affects purity and eluent volume. For high capacity 224Ra/212Pb generators that are desired for clinical use, the state-of-the-art method is to adsorb 224Ra activity on the resin to make a resin slurry first, then pack the column with the activity loaded resin slurry. In this case the 224Ra activity is distributed evenly inside the column; however, this slurry loading method suffers two major issues. First, activity loss during slurry transfer due to loss of fine resin particles. Second, manual slurry loading causes high radiation exposure to operators. To further complicate this issue, automated loading of a pre-loaded, batch style chromatography resin slurry introduces further resin/product loss, inefficiencies, and other bed volume structural abnormalities that can negatively impact fluidic and qualitative performance metrics. Thus, developing a high-capacity generator capable of using efficient activity loading method is highly desired for large scale industrial and clinical application.

The invention disclosure describes a new generator manufacturing method, instead of using only cation exchange resin as 224Ra adsorption media, a mixture of anion exchange resin and cation exchange resin is used. The cation exchange resin acts as adsorbent for 224Ra activity, while anion exchange resin acts as inert solid diluent so that the 224Ra activity can be dispersed more evenly when passed through the resin mixture, thus minimizing the radiation damage to the resin. Using this mixed anion exchange resin and cation exchange resins as activity adsorption media, efficient automatic activity loading can be achieved by simply passing a 224Ra solution through the resin media.

### SUMMARY OF THE INVENTION

Among the various aspects of the present disclosure are methods and devices for the automated production of Pb-212 from parent radionuclide Th-228. The produced Pb-212 performs as a radioactive component of radiopharmaceuticals for different Targeted Alpha-particle-Therapy and is particularly useful in the treatment of various cancers including but not limited to cancer of the pancreas, brain, ovaries, prostate, colon, breast, and neuroendocrine tumors.

The produced Pb-212 is highly purified and, when labeled with specific ligands and dosed to patients in need thereof, results in lower toxicity profiles and reduced free lead accumulation in the bone marrow, providing better effects and fewer adverse effects than Pb-212 generated through other methods or other comparable beta-particle treatments.

The process of producing radionuclides may be implemented through an automated module sequence to more efficiently synthesize the necessary radionuclides. Further included are devices within the system that provide increased operator safety and product purity.

The parent radioisotope may be selected from Th-228, or directly from Ra-224.

Radioisotopes produced by the processes of the invention may be combined with chelators and other molecules for TAT. The chelators include those selected from the group consisting of DOTA, DOTAM, TCMC, and derivatives thereof.

The purification methods used to produce the radionuclide can and will vary, as the efficacy of a radionuclide is dependent on its purity and amount of free radiation. The purification resin used in the composition can and will vary. Persons skilled in the art can appreciate that other ion exchange resins are suitable for use in the present invention. The various ion exchange resins comprise anion exchange resins and cation exchange resins with crosslinking sizes and bead polymer chemistries suitable for radionuclide adsorption, and subsequent purification processes. These resins may be utilized as the sole resin making up a column's bed volume, or may be mixed.

The activity of the parent isotope (e.g., Ra-224 or Th-228) that can be loaded onto a single column may vary widely depending on clinical demand and shielding capacity. Typical loadings include at least 5 mCi, 10 mCi, 25 mCi, 50 mCi, 100 mCi, 250 mCi, 500 mCi, and up to about 1 Ci per column. Multiple columns may be operated in series or parallel to achieve higher cumulative activity. The dosage of the resulting Pb-212 drug can and will vary.

Other features of the invention are described in detail below.

### BRIEF DESCRIPTION OF THE DRAWINGS

FIG. 1 depicts the schematic layout of the automated sequence used for the purification of Th-228 and Ra244 for the subsequent use in Pb-212 purification.

FIG. 2 depicts a first embodiment of an automated purification device comprising two multi-port apparatuses with a number of valves that control the flow of solvents, eluates, and buffers in the automated production of Pb-212 from parent radionuclide Ra-224.

FIG. 3 depicts a second embodiment of an automated purification device comprising two multi-port apparatuses with a number of valves that control the flow of solvents, eluates, and buffers in the automated production of Pb-212 from parent radionuclide Ra-224.

FIG. 4 depicts an embodiment of the radiation shielding apparatus, or RSA, from both coronal cross-section (a) and isometric (b) perspectives.

FIG. 5 depicts an embodiment of a housing cabinet for use in the purification of Pb-212.

FIG. 6 illustrates a scheme for Pb-212 purification using a tertiary amine-based resin, e.g., TK resin

FIG. 7 depicts the fractionated elution profile of Pb-212 from TK resin.

FIG. 8 depicts the yield (RCY %) of Pb-212 after loading and Pb-212 elution from the pre-purification column.

FIG. 9 depicts an example of an automated purification device for purification of Ra-224.

FIG. 10 depicts another example of an automated purification device for purification of Pb-212 from Th-228 or Ra-224 having an increased number of valves.

FIG. 11 depicts a representative chemical purity analysis of a Pb-212 purification run utilizing technology underlying the present disclosure.

### DETAILED DESCRIPTION OF THE INVENTION

Disclosed herein is an automated device to produce the highly purified, α-emitting radioisotope Pb-212 from a pre-filled column of a parent isotope Ra-224. The purified Pb-212 can be used in targeted α-particle therapy.

### Definitions

When introducing elements of the various embodiment(s) of the present disclosure, the articles “a”, “an”, “the” and “said” are intended to mean that there are one or more of the elements. The terms “comprising”, “including” and “having” are intended to be inclusive and mean that there may be additional elements other than the listed elements.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Consequently, recitation of ranges of values herein are merely intended to serve as a shorthand method of referring individually to each separate value falling within the range, unless otherwise indicated herein, and each separate value is incorporated into the specification as if it were individually recited herein.

The term “half-life” as used herein, refers to the time required for physical decay of a radioisotope to 50% of the initial/starting activity, and a drug's blood or plasma concentration to decrease by one half. This decrease in drug concentration is a reflection of its excretion or elimination after absorption is complete and distribution has reached an equilibrium or quasi equilibrium state. The half-life of a drug in the blood may be determined graphically off of a pharmacokinetic plot of a drug's blood-concentration time plot, typically after intravenous administration to a sample population. The half-life can also be determined using mathematical calculations that are well known in the art. Further, as used herein the term “half-life” also includes the “apparent half-life” of a drug. The apparent half-life may be a composite number that accounts for contributions from other processes besides elimination, such as absorption, reuptake, or enterohepatic recycling.

The term “active agent” or “drug,” as used herein, refers to any chemical that elicits a biochemical response when administered to a human or an animal. The drug may act as a substrate or product of a biochemical reaction, or the drug may interact with a cell receptor and elicit a physiological response, or the drug may bind with and block a receptor from eliciting a physiological response.

The terms “subject” or “patient” are used interchangeably herein and refer to a vertebrate, preferably a ma mm al. Mammals include, but are not limited to, humans.

The term “pure” or “purity” refers to chemical purity or radiological purity. Wherein, radiological purity refers to the purity of one radionuclide with respect to other radionuclides from which it originates by radioactive decay, as well as with regard to other radionuclides that are not part of its radioactive decay chain.

The terms “isotope,” “radioisotope,” and “radionuclide” are all used to mean a nuclide that is unstable and naturally undergoes radioactive decay over time.

The term “parent nuclide” refers to a radionuclide before radioactive decay into daughter radionuclides within its known radioactive decay chain.

The terms “first media column,” “generator” or “generator column” refers to a liquid chromatography column, or functional equivalent, containing a solid chromatography media, or resin, that is capable of adsorbing and selectively retaining the desired parent nuclide.

The term “daughter nuclide” refers to a radionuclide that has undergone radioactive decay stemming from a larger parent nuclide within its known radioactive decay chain.

The terms “finishing-column,” “post-purification column,” “second media column,” or “clean-up column” refer to a liquid chromatography column, or functional equivalent, containing a solid chromatography media, or resin, that is capable of adsorbing and selectively retaining the desired daughter nuclide.

The term “catch column” refers to a liquid chromatography column, or functional equivalent, containing a solid chromatography media, or resin, that is capable of adsorbing and selectively retaining the desired daughter nuclide, which is in fluid communication with the “generator,” “generator column,” or “first media column”.

The term “generator cassette” refers to a device comprising the “generator column,” and the “catch column”.

The description that follows includes exemplary device, methods, techniques, and/or instructions that embody techniques of the present subject matter. However, it is understood that the described embodiments may be practiced without these specific details.

### EMBODIMENTS

An embodiment of the invention is the use and manipulation of parent nuclides and daughter nuclides. The parent nuclides may be selected from the group consisting of ²²³Ra, ²²⁴Ra, ²²⁵Ac, ²⁴³Am, ²¹¹At, ²¹⁷At, ¹⁵⁴Dy, ²²⁷Th, ²²⁸Th, ²²⁹Th. The daughter nuclides may be any desirable decay product of the parent nuclide. As an example, the daughter nuclides may be ²¹²Pb, ²⁰³Pb, ⁸⁴Cu, ⁶⁷Cu, ²¹²Bi, ⁶⁸Ga, ²¹²Bi, ²¹³Bi, ¹⁴⁸Gd, ¹⁴⁶Sm, ¹⁴⁷Sm, ¹⁴⁹Tb, ⁵⁹Fe, ⁶⁰Cu, ⁶¹Cu, ⁶²Cu, ⁶¹Ga, ⁸⁶Y, ¹¹¹In, ¹⁵³Gd, ¹⁵³Sm, and ¹⁶⁶Ho. More specifically, the parent nuclides may be chosen from nuclides of thorium, radium, actinium, radon, polonium, lead, and bismuth. Even more specifically, parent nuclides consist of thorium-228 or radium-224, and daughter nuclides consist of Pb-212 and bismuth-212. Even more specifically, the daughter nuclide is Pb-212.

The parent radionuclide loaded on a single column has an activity level of at least 1 mCi, at least 2 mCi, at least 3 mCi, at least 4 mCi, at least 5 mCi, at least 6 mCi, at least 7 mCi, at least 8 mCi, at least 9 mCi, at least 10 mCi, at least 11 mCi, at least 12 mCi, at least 13 mCi, at least 14 mCi, at least 15 mCi, at least 16 mCi, at least 17 mCi, at least 18 mCi, at least 19 mCi, at least 20 mCi, at least 21 mCi, at least 22 mCi, at least 23 mCi, at least 24 mCi, at least 25 mCi, at least 26 mCi, at least 27 mCi, at least 28 mCi, at least 29 mCi, at least 30 mCi, at least 31 mCi, at least 32 mCi, at least 33 mCi, at least 34 mCi, at least 35 mCi, at least 36 mCi, at least 37 mCi, at least 38 mCi, at least 39 mCi, at least 40 mCi, at least 41 mCi, at least 42 mCi, at least 43 mCi, at least 44 mCi, at least 45 mCi, at least 46 mCi, at least 47 mCi, at least 48 mCi, at least 49 mCi, at least 50 mCi, at least 55 mCi, at least 60 mCi, at least 65 mCi, at least 70 mCi, at least 75 mCi, at least 80 mCi, at least 85 mCi, at least 90 mCi, at least 95 mCi, at least 100 mCi, at least 105 mCi, at least 110 mCi, at least 115 mCi, at least 120 mCi, at least 125 mCi, at least 130 mCi, at least 135 mCi, at least 140 mCi, at least 145 mCi, at least 150 mCi, at least 155 mCi, at least 160 mCi, at least 165 mCi, at least 170 mCi, at least 175 mCi, at least 180 mCi, at least 185 mCi, at least 190 mCi, at least 195 mCi, at least 200 mCi, at least 205 mCi, at least 210 mCi, at least 215 mCi, at least 220 mCi, at least 225 mCi, at least 230 mCi, at least 235 mCi, at least 240 mCi, at least 245 mCi, at least 250 mCi, at least 255 mCi, at least 260 mCi, at least 265 mCi, at least 270 mCi, at least 275 mCi, at least 280 mCi, at least 285 mCi, at least 290 mCi, at least 295 mCi, at least 300 mCi, at least 305 mCi, at least 310 mCi, at least 315 mCi, at least 320 mCi, at least 325 mCi, at least 330 mCi, at least 335 mCi, at least 340 mCi, at least 345 mCi, at least 350 mCi, at least 355 mCi, at least 360 mCi, at least 365 mCi, at least 370 mCi, at least 375 mCi, at least 380 mCi, at least 385 mCi, at least 390 mCi, at least 395 mCi, at least 400 mCi, at least 405 mCi, at least 410 mCi, at least 415 mCi, at least 420 mCi, at least 425 mCi, at least 430 mCi, at least 435 mCi, at least 440 mCi, at least 445 mCi, at least 450 mCi, at least 455 mCi, at least 460 mCi, at least 465 mCi, at least 470 mCi, at least 475 mCi, at least 480 mCi, at least 485 mCi, at least 490 mCi, at least 495 mCi, at least 500 mCi, at least 505 mCi, at least 510 mCi, at least 515 mCi, at least 520 mCi, at least 525 mCi, at least 530 mCi, at least 535 mCi, at least 540 mCi, at least 545 mCi, at least 550 mCi, at least 555 mCi, at least 560 mCi, at least 565 mCi, at least 570 mCi, at least 575 mCi, at least 580 mCi, at least 585 mCi, at least 590 mCi, at least 595 mCi, at least 600 mCi, at least 605 mCi, at least 610 mCi, at least 615 mCi, at least 620 mCi, at least 625 mCi, at least 630 mCi, at least 635 mCi, at least 640 mCi, at least 645 mCi, at least 650 mCi, at least 655 mCi, at least 660 mCi, at least 665 mCi, at least 670 mCi, at least 675 mCi, at least 680 mCi, at least 685 mCi, at least 690 mCi, at least 695 mCi, at least 700 mCi, at least 705 mCi, at least 710 mCi, at least 715 mCi, at least 720 mCi, at least 725 mCi, at least 730 mCi, at least 735 mCi, at least 740 mCi, at least 745 mCi, at least 750 mCi, at least 755 mCi, at least 760 mCi, at least 765 mCi, at least 770 mCi, at least 775 mCi, at least 780 mCi, at least 785 mCi, at least 790 mCi, at least 795 mCi, at least 800 mCi, at least 805 mCi, at least 810 mCi, at least 815 mCi, at least 820 mCi, at least 825 mCi, at least 830 mCi, at least 835 mCi, at least 840 mCi, at least 845 mCi, at least 850 mCi, at least 855 mCi, at least 860 mCi, at least 865 mCi, at least 870 mCi, at least 875 mCi, at least 880 mCi, at least 885 mCi, at least 890 mCi, at least 895 mCi, at least 900 mCi, at least 905 mCi, at least 910 mCi, at least 915 mCi, at least 920 mCi, at least 925 mCi, at least 930 mCi, at least 935 mCi, at least 940 mCi, at least 945 mCi, at least 950 mCi, at least 955 mCi, at least 960 mCi, at least 965 mCi, at least 970 mCi, at least 975 mCi, at least 980 mCi, at least 985 mCi, at least 990 mCi, at least 995 mCi, or at least 1 Ci.

An embodiment of the invention includes a method and device for producing the purified desired daughter nuclide for use in medicine. One embodiment comprises the production of the daughter nuclide by radioactive decay of a parent nuclide contained within a first solid medium to which the parent nuclide is bound. The extraction of the daughter nuclide from the first solid medium is in the form of an aqueous solution. The method further comprises radiological and chemical purification of the daughter nuclide in said aqueous solution via a second solid medium through which the said aqueous solution is passed, binding the daughter nuclide and washing away radiological and chemical impurities. The daughter nuclide is then eluted in an aqueous solution from the second solid medium to provide the purified daughter nuclide.

An embodiment of the invention includes a method and device for producing purified desired daughter nuclides for use in medicine via the decay of a parent nuclide in a device comprising a first solid media that binds the parent nuclide but does not bind the daughter nuclide.

A more specific embodiment of the invention includes a method and device for producing purified Pb-212 for use in medicine via the decay of thorium-228 or radium-224 in a device containing one or more of a first solid media that binds thorium-228 or radium-224 but does not bind Pb-212.

An embodiment of the invention also comprises the system utilized for the purification of the desired daughter nuclide from its parent. That system may comprises an at least one housing cabinet, and at least one automated purification unit, and at least one generator column that may contain at least one type of solid media, and at least one catch column, and at least one finishing column containing only one solid media, and an at least one radiation shielding apparatus (“RSA”) encompassing the at least one generator column, and an at least one catch column.

Another embodiment of the system includes a housing cabinet comprising materials and a thickness appropriate for the size and weight of the materials held within that cabinet housing the other components or devices of the system. For instance, the housing cabinet may be made of metal or a metal alloy. In a different embodiment, materials and a thickness appropriate for the type and amount of radioactivity housed within said cabinet, providing another layer of radiation shielding. The automated purification unit may be a HPLC or other suitable device. The at least one generator column that may contain at least one type of solid media may be a liquid chromatography column containing either one cationic resin suitable for the adsorption and selective retention of the parent nuclide alone, or a heterogeneous mixture of that cationic resin with any other suitable non-cationic resins with that mixture comprising any ratio of the two resins. The at least one purification device containing only one solid media may be a liquid chromatography column containing a single resin suitable for the adsorption and selective retention of the desired daughter nuclide. The at least one RSA may encompass or house the at least one generator cassette in a closed environment, while maintaining that generator cassette's ability to communicate fluidically with other components of this system. Namely, the at least one automated purification unit, and the at least one finishing column.

In one embodiment of the invention, a solid media binding thorium-228 or radium-224 is a column comprising a cation exchange resin. More specifically, an embodiment of the invention uses Bio-Rad AGMP1 resin. Another embodiment of the invention uses Bio-Rad AMP50 resin. Yet another embodiment of the invention uses Bio-Rad AG50W resin. Yet another embodiment of the invention uses Bio-Rad Chelex 100 resin. Yet another embodiment of the invention uses Purolite NRW100 resin. Yet another embodiment of the invention uses Purolite NRW1100 resin. Yet another embodiment of the invention uses Purolite NRW1160 resin. Yet another embodiment of the invention uses Purolite NRW1160LS resin. Yet another embodiment of the invention uses Purolite NRW150 resin. Yet another embodiment of the invention uses Purolite NRW160 resin. Yet another embodiment of the invention uses Purolite NRW160LS resin. Other embodiments of the invention use TrisKem resin (TK resin). One other embodiment of the invention uses TrisKem Actinide resin. Another embodiment of the invention uses TrisKem DGA resin. Yet another embodiment of the invention uses TrisKem Guard resin. Yet another embodiment of the invention uses TrisKem KNiFC-PAN resin. Yet another embodiment of the invention uses TrisKem LN resin. Yet another embodiment of the invention uses TrisKem LN2 resin. Yet another embodiment of the invention uses TrisKem LN3 resin. Yet another embodiment of the invention uses TrisKem MNO2-PAN resin. Yet another embodiment of the invention uses TrisKem NI resin. Yet another embodiment of the invention uses TrisKem PB resin. Yet another embodiment of the invention uses TrisKem Prefilter resin. Yet another embodiment of the invention uses TrisKem RE resin. Yet another embodiment of the invention uses TrisKem SR resin. Yet another embodiment of the invention uses TrisKem TBP resin. Yet another embodiment of the invention uses TrisKem TEVA resin. Yet another embodiment of the invention uses TrisKem TK100 resin. Yet another embodiment of the invention uses TrisKem TK101 resin. Yet another embodiment of the invention uses TrisKem TK102 resin. Yet another embodiment of the invention uses TrisKem TK200 resin. Yet another embodiment of the invention uses TrisKem TK201 resin. Yet another embodiment of the invention uses TrisKem TK202 resin. Yet another embodiment of the invention uses TrisKem TK211 resin. Yet another embodiment of the invention uses TrisKem TK212 resin. Yet another embodiment of the invention uses TrisKem TK213 resin. Yet another embodiment of the invention uses TrisKem TK221 resin. Yet another embodiment of the invention uses TrisKem TK225 resin. Yet another embodiment of the invention uses TrisKem TK400 resin. Yet another embodiment of the invention uses TrisKem TRU resin. Yet another embodiment of the invention uses TrisKem UTEVA resin. Yet another embodiment of the invention uses TrisKem WBEC resin. Yet another embodiment of the invention uses TrisKem ZR resin. Persons skilled in the art can appreciate that other ion exchange resins are suitable for use in the present invention.

In one embodiment of the invention, when preparing the generator, the column may be packed solely with a resin suitable for the adsorption and selective retention of the desired parent nuclide. More specifically, the column is packed with any of the resins detailed in the previous paragraph, or one that persons skilled in the art may deem functionally equivalent in its abilities to adsorb and selectively retain the desired parent nuclide.

In another embodiment, the generator is packed with a heterogenous mixture of resins, with one of those resins being suitable for the adsorption and selective retention of the desired parent nuclide. The at least one other resin comprising that heterogeneous mixture may be any other resin that maintains column performance and physical stability, while remaining inert as it pertains to its ability to adsorb, bind, retain, or otherwise interact with the desired parent nuclide in a manner contrary to the function of the generator column. The ratio or ratios of the resins contained within the generator column may be any numbers but 0, or 100. As a more detailed example, the generator column may be packed with a mixture of any cation exchange resin of paragraph [0053] with any anion exchange resin that is of similar size and density of the cation exchange resin, such that the generator column's physical performance is not impaired. The ratio of anion to cation exchange resin can range from 1:99 to 99:1. The inert resin (i.e., the anion exchange media) may be damaged by a-decay instead of the functionally active cation exchange resin. Thus, allowing for a greater percentage of viable cation exchange resin throughout the decay process, and increasing yields and purity levels.

In yet another embodiment, the previous embodiments may contain a chromatographic media that is not an anion exchange resin, but that has a similar size, compression ratio, and chemistry to absorb a-decay without negatively impacting column fluid dynamics properties like back-pressure, and flow-rate. Some examples might be size exclusion or other non-ionic resins.

In embodiments, the resin mixture of the first solid media may comprise the cationic exchange resin and the at least one other chromatography resin in various ratios by weight or by volume. For example, the ratio of cationic exchange resin to the at least one other chromatography resin may be 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:34, 65:35, 64:36, 63:37, 62:38, 61:39, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, or 1:99.

In various embodiments of the invention, the resin mixture within the first solid media may be formulated with various proportions of the cationic exchange resin and the at least one other chromatography resin. The proportion of the cationic exchange resin relative to the total resin mixture, by weight or volume, may be selected to optimize performance. For example, the amount of cationic exchange resin may be from about 1% to about 99%, from about 5% to about 95%, from about 10% to about 90%, from about 15% to about 85%, from about 20% to about 80%, from about 25% to about 75%, or from about 30% to about 70%. In certain embodiments where a higher proportion of cationic exchange resin is desired, its amount may be from about 60% to about 99%, from about 70% to about 95%, or from about 75% to about 90%. In alternative embodiments where a lower proportion of cationic exchange resin is utilized, its amount may be from about 1% to about 40%, from about 5% to about 35%, or from about 10% to about 30%. In yet other embodiments, the amount of cationic exchange resin may be from about 35% to about 65%.

In other embodiments, a substantially balanced mixture of the cationic exchange resin and the at least one other chromatography resin is utilized. In such embodiments, the amount of cationic exchange resin in the total resin mixture, by weight or volume, may be from about 40% to about 60%. The amount may be from about 41% to about 59%, from about 42% to about 58%, from about 43% to about 57%, from about 44% to about 56%, from about 45% to about 55%, from about 46% to about 54%, from about 47% to about 53%, from about 48% to about 52%, or from about 49% to about 51%. In another embodiment, the amount of cationic exchange resin is about 50% of the total resin mixture, corresponding to a 50:50 ratio of the resins.

In further embodiments of the invention, the resin mixture within the first solid media may be formulated with various proportions of the cationic exchange resin and an anion exchange resin to achieve desired performance characteristics. The proportion of cationic exchange resin relative to the total resin mixture, by weight or volume, may be selected from a plurality of ranges. For instance, the amount of cationic exchange resin may be from about 1% to about 99%, from about 5% to about 95%, from about 10% to about 90%, or from about 20% to about 80%. In certain embodiments where a higher proportion of cationic exchange resin is advantageous, its amount in the mixture may be from about 50% to about 99%, from about 60% to about 95%, from about 70% to about 90%, or from about 75% to about 85%. In alternative embodiments where a lower proportion of cationic exchange resin is utilized, its amount may be from about 1% to about 50%, from about 5% to about 40%, from about 10% to about 30%, or from about 15% to about 25%. In yet further embodiments, the resin mixture may be substantially balanced, comprising from about 40% to about 60%, or from about 45% to about 55%, of the cationic exchange resin.

In embodiments, the resin mixture of the first solid media may comprise the cationic exchange resin and anion exchange chromatography resin in various ratios by weight or by volume. For example, the ratio of cationic exchange resin to anion exchange chromatography resin may be 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:34, 65:35, 64:36, 63:37, 62:38, 61:39, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, or 1:99.

In other embodiments, a substantially balanced mixture of the cationic exchange resin and anion exchange chromatography resin is utilized. In such embodiments, the amount of cationic exchange resin in the total resin mixture, by weight or volume, may be from about 40% to about 60%. The amount may be from about 41% to about 59%, from about 42% to about 58%, from about 43% to about 57%, from about 44% to about 56%, from about 45% to about 55%, from about 46% to about 54%, from about 47% to about 53%, from about 48% to about 52%, or from about 49% to about 51%. In another embodiment the amount of cationic exchange resin is about 50% of the total resin mixture, corresponding to a 50:50 ratio of the resins.

In some embodiments, the purification resin used in the at least one generator may be selected from the group consisting of Bio-Rad AG MP-1, Bio-Rad AG MP-50, Bio-Rad AG 50-W, Bio-Rad Chelex 100, Purolite NRW100, Purolite NRW1100, Purolite NRW1160, Purolite NRW1160LS, Purolite NRW150, Purolite NRW160, Purolite NRW160LS, TrisKem Actinide resin, TrisKem DGA resin, TrisKem Guard resin, TrisKem KNiFC-PAN resin, TrisKem LN resin, TrisKem LN2 resin, TrisKem LN3 resin, TrisKem MNO2-PAN resin, TrisKem NI resin, TrisKem PB resin, TrisKem Prefilter resin, TrisKem RE resin, TrisKem SR resin, TrisKem TBP resin, TrisKem TEVA resin, TrisKem TK100 resin, TrisKem TK101 resin, TrisKem TK102 resin, TrisKem TK200 resin, TrisKem TK201 resin, TrisKem TK202 resin, TrisKem TK211 resin, TrisKem TK212 resin, TrisKem TK213 resin, TrisKem TK221 resin, TrisKem TK225 resin, TrisKem TK400 resin, TrisKem TRU resin, TrisKem UTEVA resin, TrisKem WBEC resin, and TrisKem ZR resin. TrisKem resin can also be referred to as TK resin. Persons skilled in the art can appreciate that other ion exchange resins are suitable for use in the present invention. The various ion exchange resins comprise anion exchange resins and cation exchange resins with crosslinking sizes and bead polymer chemistries suitable for radionuclide adsorption, and subsequent purification processes. These resins may be utilized as the sole resin making up a column's bed volume, or may be mixed in a step-wise or gradient fashion down the axial axis of the bed volume.

The activity of the parent isotope (e.g., Ra-224 or Th-228) that can be loaded onto a single column may vary widely depending on clinical demand and shielding capacity. Typical loadings include at least 5 mCi, 10 mCi, 25 mCi, 50 mCi, 100 mCi, 250 mCi, 500 mCi, and up to about 1 Ci per column. Multiple generator cassettes (i.e., columns) may be operated in series or parallel to achieve higher cumulative activity.

The activity of the parent radionuclide (such as Ra-224 or Th-228) loaded onto a single generator column can be selected from a wide range of values based on factors including, but not limited to, clinical demand, the specific application, and the shielding capacity of the apparatus. For example, the activity loaded on a single column may be at least 5 mCi, at least 10 mCi, at least 15 mCi, at least 20 mCi, at least 25 mCi, at least 30 mCi, at least 40 mCi, at least 50 mCi, at least 60 mCi, at least 70 mCi, at least 75 mCi, at least 80 mCi, at least 90 mCi, at least 100 mCi, at least 125 mCi, at least 150 mCi, at least 175 mCi, at least 200 mCi, at least 225 mCi, at least 250 mCi, at least 275 mCi, at least 300 mCi, at least 350 mCi, at least 400 mCi, at least 450 mCi, at least 500 mCi, at least 550 mCi, at least 600 mCi, at least 650 mCi, at least 700 mCi, at least 750 mCi, at least 800 mCi, at least 850 mCi, at least 900 mCi, at least 950 mCi, or at least 1 Ci.

The activity of the parent radionuclide loaded onto a single generator column may be selected to fall within a variety of ranges depending on the intended use. In embodiments, the activity may be from about 5 mCi to about 1 Ci. In other embodiments, the activity may be within a cascaded series of narrower ranges, for instance from about 10 mCi to about 900 mCi, from about 25 mCi to about 750 mCi, from about 50 mCi to about 600 mCi, from about 75 mCi to about 500 mCi, or from about 100 mCi to about 400 mCi. For certain applications, the activity range may be from about 150 mCi to about 300 mCi. In alternative clinical scenarios, the activity range may be from about 25 mCi to about 100 mCi, or from about 50 mCi to about 250 mCi. Each of these ranges is contemplated as a distinct embodiment of the loading capacity of the generator column and scales with the volume of resin utilized.

In various embodiments, the activity of the parent radionuclide loaded onto a single generator column is within a specified range. For instance, the activity may be from about 5 mCi to about 1 Ci, from about 10 mCi to about 750 mCi, from about 25 mCi to about 500 mCi, or from about 50 mCi to about 250 mCi. In certain embodiments the range may be from about 100 mCi to about 1 Ci, from about 200 mCi to about 800 mCi, or from about 250 mCi to about 500 mCi. In other embodiments the range may be from about 5 mCi to about 100 mCi, from about 10 mCi to about 75 mCi, or from about 25 mCi to about 50 mCi.

To achieve a cumulative activity level greater than the capacity or desired output of a single generator column, some embodiments of the invention may utilize multiple generator columns. For example, two, three, four, five, or six generator cassettes may be operated simultaneously or sequentially. Such operation may involve connecting the columns in series, such that the eluate from one column passes through the next, or in parallel, where the eluate from each column is combined. This multi-column configuration allows for the production of significantly higher total activities to meet high-demand clinical or manufacturing scenarios.

In another embodiment, the bed volume of the initial purification column is 1 mL. However, that volume may be based on the amount of activity being added to that column. As such, the bed volume may be increased in a linear fashion in order to accommodate greater levels of radioactivity and increase manufacturing output and efficiency. For instance, if Pb-212 is required to be purified from 10 Ci of the parent nuclide, a larger initial purification column should be prepared in what may consist of a 10 mL bed volume in any manner consistent with the previous and foregoing embodiments.

In one embodiment of the invention, the parent nuclide, while bound to the resin, produces Pb-212 via radioactive decay, which can be eluted from the resin.

The generator may comprise a mixture of at least two resins to act as an absorbent for parent nuclide activity and to disperse parent nuclide radioactivity evenly when the parent nuclide is passed through the column in order to minimize radiation damage to the functionally active resin material. One of the resins is a cation exchange resin for Ra-224 adsorption and selective retention. The other resin may be any other resin of suitable nature in that fluid dynamics, column pressures, and column performance are not negatively affected. One skilled in the art will recognize characteristics like incompatible/competing chemistries, bead size, and compression resistance as being important to the selection of that second resin. The catch column is the most proximally located chromatographic entity along the efferent flow path of the generator, and provides redundancy in order to capture Ra-224/Pb-212 that has escaped the, generator column due to α-particle induced cation resin damage, overloading or other causes. The catch column may comprise the same, or a different chromatography resin than the generator. The catch column may contain the same, or functional equivalent chromatography resin as the generator.

Another embodiment includes a generator cassette. The generator comprising a single chromatography resin type suitable for the absorption and selective retention of Ra-224/Pb212. The catch column is the most proximally located chromatographic entity along the efferent flow path of the generator, and provides redundancy in order to capture Ra-224/Pb-212 that has escaped the generator column. The catch column may be directly attached to the generator column, constituting a single entity (i.e., generator cassette). The catch column may comprise the same, or a different chromatography resin than the generator. The catch column may contain the same, or functional equivalent chromatography resin as the generator.

In an additional embodiment, the generator has an inner diameter greater than or equal to that of the catch column. The catch column may consist of solely cationic exchange media that is the same, or functionally equivalent to that of the generator.

An embodiment of the invention includes at least one generator cassette used in the production of Pb-212. For example, one generator is used to produce Pb-212. In another example, two generators are used to produce Pb-212. In another example, three generators are used to produce Pb-212. In another example, four generators are used to produce Pb-212. In another example, five generators are used to produce Pb-212. In another example, six generators are used to produce Pb-212.

In another embodiment of the invention, the generator cassettes are connected in series. In yet another embodiment, the generator cassettes are connected in parallel loops. In another embodiment, the 3 generator cassettes are connected to the system in series and in parallel, or only in series. In another embodiment, the 4 generator cassettes are used in series and in parallel, with no more than 3 generator cassettes being connected in series. More specifically, the generator cassettes are connected in either a 2×2, or 3×1 configuration. In another embodiment using 5 generator cassettes, no more than three generator cassettes may be connected in series, such that two are configured in parallel (i.e., a 3×2 configuration). In a different embodiment, 6 generator cassettes are used, resulting in a 3 generator cassettes being connected in series in both parallel loops.

A specific embodiment of the invention comprises the use of water or an aqueous solution to elute the Pb-212 that does not bind to the resin. More specifically, the aqueous solution can be an aqueous acid solution. As an example, the acid can be hydrochloric acid. In another example, the acid can be nitric acid. In another embodiment, the aqueous solution is a buffer solution. As an example, the buffer solution can be a sodium acetate buffer solution. In another example, the buffer solution can be an a mm onium acetate buffer solution. The concentration may or may not be adjusted to yield a pH suitable for the elution of Pb-212.

In embodiments of the invention, the buffer concentration may be from about 0.1 M to about 1 M, from about 0.1 M to about 0.9 M, from about 0.2 M to about 0.8 M, from about 0.3 M to about 0.7 M, from about 0.3M to about 0.6 M, or from about 0.4 M to about 0.5 M. In one embodiment of the invention, the elution of Pb-212 is carried out at a pH from about 4.5 to about 7.5, from about 4.6 to about 7.4, from about 4.7 to about 7.3, from about 4.8 to about 7.2, from about 4.9 to about 7.1, from about 5.0 to about 7.0, from about 5.1 to about 6.9, from about 5.2 to about 6.8, from about 5.3 to about 6.7, from about 5.4 to about 6.6, from about 5.5 to about 6.5, from about 5.6 to about 6.4, from about 5.7 to about 6.3, from 5.8 to about 6.2, from about 5.9 to about 6.1, from about 6.0 to about 6.1, or from about 5.8 to about 6.0. In another embodiment, the pH is about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, or about 7.5.

In still a further embodiment, the generator cassette(s) are embodiments are encompassed by a RSA. In another embodiment of the invention, each individual generator cassette is encompassed by a RSA. In yet another embodiment of the invention, all generator cassettes together are encompassed by a RSA. Said radiation shielding comprises materials effective in blocking radiation and allowing exposure to users of the invention to radiation at safe levels. Radiation shielding can comprise lead, depleted uranium, antimony, tungsten, tin, bismuth, cerium, or telluride. Said radiation shielding also can also comprise material or materials comprising polymer composites of lead, depleted uranium, antimony, tungsten, tin, bismuth, cerium, or telluride. Said radiation shielding can comprise single-walled carbon nanotubes (SWNTs), or boron nitride nanotubes (BNNTs). Said radiation shielding can have a thickness from about 0.01 mm to about 0.04 mm, from about 0.05 mm to about 0.09 mm, from about 0.10 mm to about 0.99 mm, from about 1.00 mm to about 1.99 mm, from about 2.00 mm to about 2.99 mm, from about 3.00 mm to about 3.99 mm, from about 4.00 mm to about 4.99 mm, from about 5.00 mm to about 5.99 mm, from about 6.00 mm to about 6.99 mm, from about 7.00 mm to about 7.99 mm, from about 8.00 mm to about 8.99 mm, from about 9.00 mm to about 9.99 mm, from about 1.00 cm to about 1.99 cm, from about 2.00 cm to about 2.99 cm, from about 3.00 cm to about 3.99 cm, from about 4.00 cm to about 4.99 cm, from about 5.00 cm to about 5.99 cm, from about 6.00 cm to about 6.99 cm, from about 7.00 cm to about 7.99 cm, from about 8.00 cm to about 8.99 cm, or from about 9.00 cm to about 9.99 cm. In still another embodiment, the shielding can have a thickness of about 2.0 cm, 2.1 cm, 2.2 cm, 2.3 cm, 2.4 cm, 2.5 cm, 2.6 cm, 2.7 cm, 2.8 cm, 2.9 cm, or 3.0 cm.

In one embodiment the RSA is comprised of a material that sufficiently blocks radioactive decay products of the isotope being purified is a closed system.

A person skilled in the art will understand that an advantage of housing the parent nuclide purification processes in an appropriately shielded, closed system will be that gasses containing contaminating decay products (like Rn-220) are sequestered from the desired product and intermediates. A person skilled in the art will also appreciate that such an apparatus reduces operator exposure to ga mm a radiation, and other forms of radioactive decay products. In another embodiment of the invention, the generator cassette has an afferent inlet and an efferent outlet. That afferent inlet traverses the RSA wall by way of a sealed rubber gasket or similar feature, with the efferent outlet traversing the RSA wall by substantially similar or identical means. Ideally, the afferent inlet and efferent outlets utilize physically distinct and separate structural openings, or bores allowing for their traversal of the RSA wall.

A generator cassette is optimally contained within the above appropriately shielded, closed system apparatus, and the RSA is further contained within a second layer shielding apparatus. In other embodiments, each individual column is equipped with radiation shielding. In another embodiment, each generator cassette is equipped with radiation shielding. In yet another embodiment, all columns together are equipped with radiation shielding. Said radiation shielding comprises materials effective in blocking radiation and allowing exposure to users of the invention to radiation at safe levels. Radiation shielding can comprise lead, depleted uranium, antimony, tungsten, tin, bismuth, cerium, or telluride. Radiation shielding can also comprise polymer composites of lead, depleted uranium, antimony, tungsten, tin, bismuth, cerium, or telluride. Radiation shielding can comprise single-walled carbon nanotubes (SWNTs), or boron nitride nanotubes (BNNTs). Said radiation shielding has a thickness from about 0.01 mm to about 0.04 mm, from about 0.05 mm to about 0.09 mm, from about 0.10 mm to about 0.99 mm, from about 1.00 to about 1.99 mm, from about 2.00 mm to about 2.99 mm, from about 3.00 mm to about 3.99 mm, from about 4.00 mm to about 4.99 mm, from about 5.00 mm to about 5.99 mm, from about 6.00 mm to about 6.99 mm, from about 7.00 mm to about 7.99 mm, from about 8.00 mm to about 8.99 mm, from about 9.00 mm to about 9.99 mm, from about 1.00 cm to about 1.99 cm, from about 2.00 cm to about 2.99 cm, from about 3.00 cm to about 3.99 cm, from about 4.00 cm to about 4.99 cm, from about 5.00 cm to about 5.99 cm, from about 6.00 cm to about 6.99 cm, from about 7.00 cm to about 7.99 cm, from about 8.00 cm to about 8.99 cm, or from about 9.00 cm to about 9.99 cm. In still another embodiment, the shielding can have a thickness of about 2.0 cm, 2.1 cm, 2.2 cm, 2.3 cm, 2.4 cm, 2.5 cm, 2.6 cm, 2.7 cm, 2.8 cm, 2.9 cm, or 3.0 cm.

Like the RSA housing the generator cassette, the housing cabinet may, in one embodiment, provide a second layer shielding by way of being composed of a material suitable to shield an operator or the outside environment from ga mm a-radiation, and other harmful or contaminating radioactive decay products. One having skill in the art will realize the choice of material and required thickness thereof is dependent upon the type of nuclides being handled and the amount of activity housed within that system for any given purification process.

The resulting aqueous solution of containing Pb-212 of the previous embodiments can be further purified using one or more of a second solid media. In one embodiment, a second solid media can be contained in a column which retains Pb-212 from the aqueous solution and elutes any radiological and chemical impurities away from the Pb-212.

In an embodiment of the invention, the second solid media is a chromatography column used to purify Pb-212. More specifically, the second solid media that binds Pb-212 can be a liquid chromatography column used to purify Pb-212. In another embodiment the liquid chromatography column comprises a resin. In a more specific embodiment the resin is Bio-Rad AGMP1 resin. Another embodiment of the invention uses Bio-Rad AMP50 resin. Yet another embodiment of the invention uses Bio-Rad AG50W resin. Yet another embodiment of the invention uses Bio-Rad Chelex 100 resin. Yet another embodiment of the invention uses Purolite NRW100 resin. Yet another embodiment of the invention uses Purolite NRW1100 resin. Yet another embodiment of the invention uses Purolite NRW1160 resin. Yet another embodiment of the invention uses Purolite NRW1160LS resin. Yet another embodiment of the invention uses Purolite NRW150 resin. Yet another embodiment of the invention uses Purolite NRW160 resin. Yet another embodiment of the invention uses Purolite NRW160LS resin. Other embodiments of the invention use TrisKem resin (TK resin). Yet another embodiment of the invention uses TrisKem Actinide resin. Another embodiment of the invention uses TrisKem DGA resin. Yet another embodiment of the invention uses TrisKem Guard resin. Yet another embodiment of the invention uses TrisKem KNiFC-PAN resin. Yet another embodiment of the invention uses TrisKem LN resin. Yet another embodiment of the invention uses TrisKem LN2 resin. Yet another embodiment of the invention uses TrisKem LN3 resin. Yet another embodiment of the invention uses TrisKem MNO2-PAN resin. Yet another embodiment of the invention uses TrisKem NI resin. Yet another embodiment of the invention uses TrisKem PB resin. Yet another embodiment of the invention uses TrisKem Prefilter resin. Yet another embodiment of the invention uses TrisKem RE resin. Yet another embodiment of the invention uses TrisKem SR resin. Yet another embodiment of the invention uses TrisKem TBP resin. Yet another embodiment of the invention uses TrisKem TEVA resin. Yet another embodiment of the invention uses TrisKem TK100 resin. Yet another embodiment of the invention uses TrisKem TK101 resin. Yet another embodiment of the invention uses TrisKem TK102 resin. Yet another embodiment of the invention uses TrisKem TK200 resin. Yet another embodiment of the invention uses TrisKem TK201 resin. Yet another embodiment of the invention uses TrisKem TK202 resin. Yet another embodiment of the invention uses TrisKem TK211 resin. Yet another embodiment of the invention uses TrisKem TK212 resin. Yet another embodiment of the invention uses TrisKem TK213 resin. Yet another embodiment of the invention uses TrisKem TK221 resin. Yet another embodiment of the invention uses TrisKem TK225 resin. Yet another embodiment of the invention uses TrisKem TK400 resin. Yet another embodiment of the invention uses TrisKem TRU resin. Yet another embodiment of the invention uses TrisKem UTEVA resin. Yet another embodiment of the invention uses TrisKem WBEC resin. Yet another embodiment of the invention uses TrisKem ZR resin. In still another embodiment, the resin is TK201. Persons skilled in the art can appreciate that other ion exchange resins are suitable for use in the present invention.

In an embodiment of the methods of the invention, the radiological and chemical impurities that do not bind to the resin of the finishing column are eluted from the resin via water or an aqueous solution. More specifically, the aqueous solution can be an aqueous acid solution. As an example, the acid can be hydrochloric acid. In another example, the acid can be nitric acid. In another embodiment, the aqueous solution is a buffer solution. As an example, the buffer solution can be a sodium acetate buffer solution. In another example, the buffer solution can be an a mm onium acetate buffer solution. The concentration may or may not be adjusted to yield a pH suitable for the elution of radiological and chemical impurities. In embodiments of the invention, the buffer concentration may be from about 0.1 M to about 1.0 M, from about 0.2 M to about 0.8 M, from about 0.3 M to about 0.7 M, from about 0.3M to about 0.6 M, or from about 0.4 M to about 0.5 M. In one embodiment of the invention the elution of radiological and chemical impurities is carried out at a pH from about 4.5 to about 7.5, from about 4.6 to about 7.4, from about 4.7 to about 7.3, from about 4.8 to about 7.2, from about 4.9 to about 7.1, from about 5.0 to about 7.0, from about 5.1 to about 6.9, from about 5.2 to about 6.8, from about 5.3 to about 6.7, from about 5.4 to about 6.6, from about 5.5 to about 6.5, from about 5.6 to about 6.4, from about 5.7 to about 6.3, from 5.8 to about 6.2, or from about 5.9 to about 6.1, from about 6.0 to about 6.1, or from about 5.8 to about 6.0. In another embodiment, the pH is about 4.5, about 4.6, about 4.7, about 4.8, about 4.9, about 5.0, about 5.1, about 5.2, about 5.3, about 5.4, about 5.5, about 5.6, about 5.7, about 5.8, about 5.9, about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, or about 7.5. The solid phase of the liquid chromatography column may be washed to elute radiological and chemical impurities from the bound Pb-212.

An embodiment of the invention includes that there is at least one column used in the elution of radiological and chemical impurities from Pb-212. For example, one column is used to elute radiological and chemical impurities. In another example, two columns are used to elute radiological and chemical impurities. In another example, three columns are used to elute radiological and chemical impurities. In another example, four columns are used to elute radiological and chemical impurities. In another example, five columns are used to elute radiological and chemical impurities. In another example, six columns are used to elute radiological and chemical impurities. In one embodiment of the invention, the columns are connected in series. In another embodiment, the columns are connected in parallel. In a different embodiment the columns are connected to, or in fluid communication with, the automated purification unit in series and in parallel.

In one embodiment, the radiological purity of Pb-212 produced by the invention is greater than or equal to about 90%. In another embodiment, the radiological purity of Pb-212 produced by the invention is greater than or equal to about 95%. In yet another embodiment, the radiological purity is at least about 90%, at least about 91%, at least about 92%, at least about 93%, at least about 94%, at least about 95%, at least about 96%, at least about 97%, at least about 98%, or at least about 99%. In another embodiment, the radiological purity of Pb-212 is greater than or equal to 99.5%. In another embodiment, the radiological purity of Pb-212 is greater than or equal to 99.995%.

Radiopharmaceutical formulations prepared from the purified Pb-212 can be administered over a broad activity window tailored to tumor burden, patient weight, and dosing schedule. Representative single-patient doses range from about 1 mCi to about 55 mCi of Pb-212, for example about 15 mCi, about 25 mCi, about 35 mCi, about 45 mCi, or about 55 mCi. The dosage of the resulting Pb-212 drug can and will vary. In some embodiments, the total dosage of Pb-212 present in a radiopharmaceutical composition may be at least 1 mCi, at least 2 mCi, at least 3 mCi, at least 4 mCi, at least 5 mCi, at least 6 mCi, at least 7 mCi, at least 8 mCi, at least 9 mCi, at least 10 mCi, at least 11 mCi, at least 12 mCi, at least 13 mCi, at least 14 mCi, at least 15 mCi, at least 16 mCi, at least 17 mCi, at least 18 mCi, at least 19 mCi, at least 20 mCi, at least 21 mCi, at least 22 mCi, at least 23 mCi, at least 24 mCi, at least 25 mCi, at least 26 mCi, at least 27 mCi, at least 28 mCi, at least 29 mCi, at least 30 mCi, at least 31 mCi, at least 32 mCi, at least 33 mCi, at least 34 mCi, at least 35 mCi, at least 36 mCi, at least 37 mCi, at least 38 mCi, at least 39 mCi, at least 40 mCi, at least 41 mCi, at least 42 mCi, at least 43 mCi, at least 44 mCi, at least 45 mCi, at least 46 mCi, at least 47 mCi, at least 48 mCi, at least 49 mCi, at least 50 mCi, at least 51 mCi, at least 52 mCi, at least 53 mCi, at least 54 mCi, or at least 55 mCi. In some embodiments, the total dosage of Pb-212 present in the radiopharmaceutical composition may range from about 0.5 mCi to 5.0 mCi, about 5.0 mCi to 10 mCi, about 10 mCi to 15 mCi, about 20 mCi to 30 mCi, about 15 mCi to 25 mCi, about 25 mCi to 35 mCi, about 30 mCi to 40 mCi, about 35 mCi to 45 mCi, about 40 mCi to 50 mCi, or about 45 mCi to 55 mCi. The dosage may be about 15 mCi, 20 mCi, 25 mCi, 30 mCi, 35 mCi, 40 mCi, 45 mCi, 50 mCi, or about 55 mCi.

In one embodiment, the method and device of the invention is designed for automated implementation in a closed system comprising a means for eluting Pb-212 from a parent nuclide, a means for purifying the Pb-212 with one or more liquid chromatography columns, a means for collecting the purified Pb-212, and an electronic program for running automation means for eluting Pb-212 from parent nuclide, a means for purifying Pb-212, and a means for collecting purified Pb-212.

The purified Pb-212 of the invention can be used as a radiolabel in a radiopharmaceutical. In one embodiment, the Pb-212 can be coordinated to a chelator that comprises a targeting ligand. The chelator may be selected from the group consisting of DOTA, DOTAM, TCMC, and derivatives thereof, or other compounds appreciated by one of skill in the art.

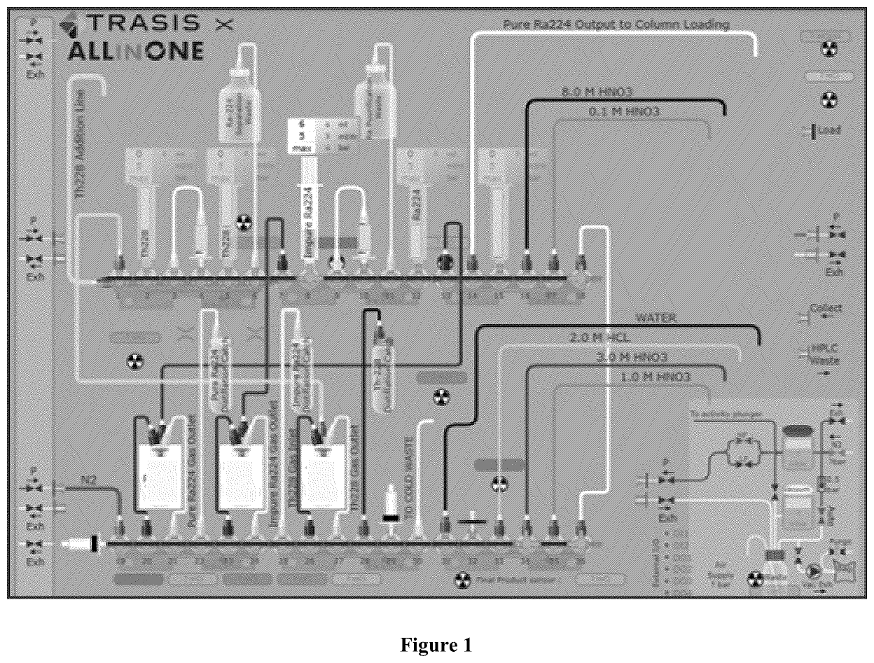

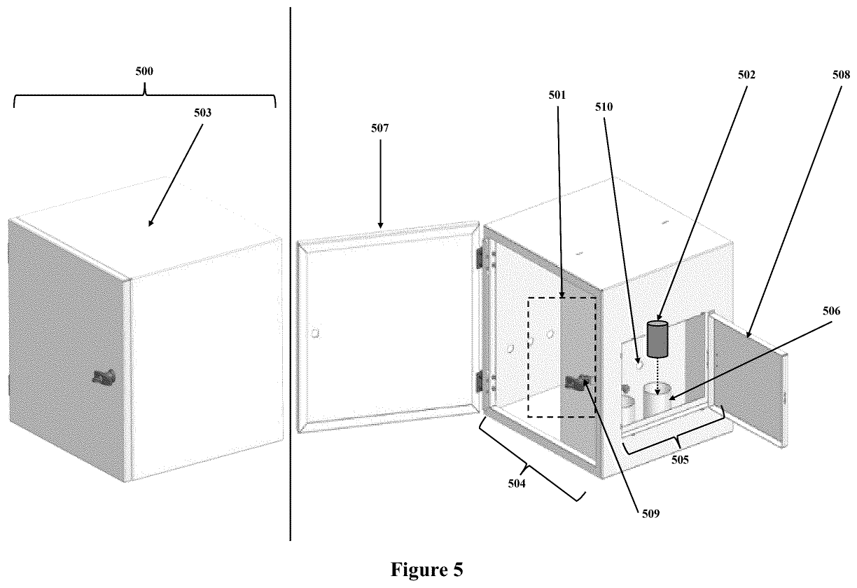

In another embodiment, the invention comprises a cabinet for housing the components of the device. For example, any or all of the devices shown in FIGS. 1-4, 9-10 can be contained within a housing. FIG. 5 depicts different views of a housing for valve ports of the invention. The housing unit is comprised of a cabinet that may accommodate different purification automation systems that allow for the efficient and reproducible production and purification of high activity of Pb-212 using Ra-224/Pb-212 generators. One skilled in the art will understand that the appropriate material type and thickness of the radiation shielding comprised by the housing unit depends on the nature of the radioactive material being handled, and the amount of radioactivity being processed in that housing. As a non-limiting example for the purpose and function of that housing, a high pressure liquid chromatography system having flow rates and valves sufficient to perform these procedures may be utilized in order to facilitate the purification of Pb-212 from up to six Ra-224/Pb-212 generators. It should be noted, as one skilled in the art will appreciate, that the electronic components of the automation systems are internally shielded or separated from the Ra-224/Pb-212 generators to prevent contamination, damage, or interference with those automation electronics by radiation and radioactive decay products.

### SPECIFIC EMBODIMENTS

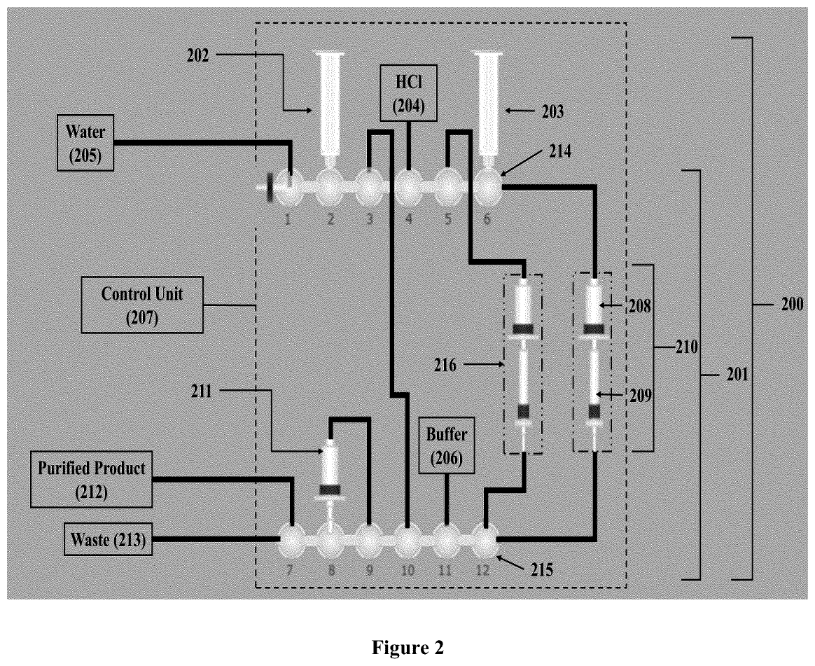

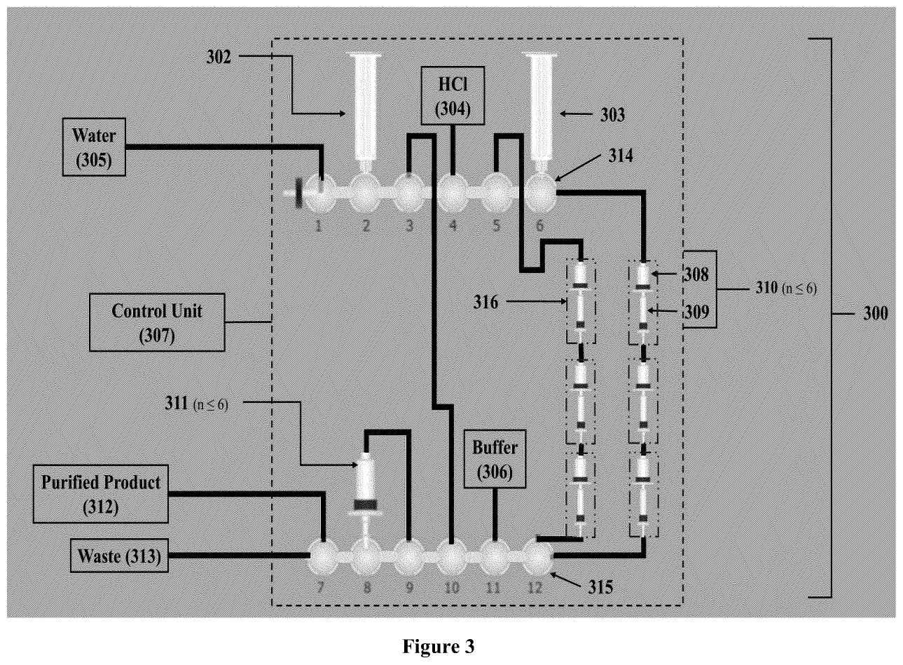

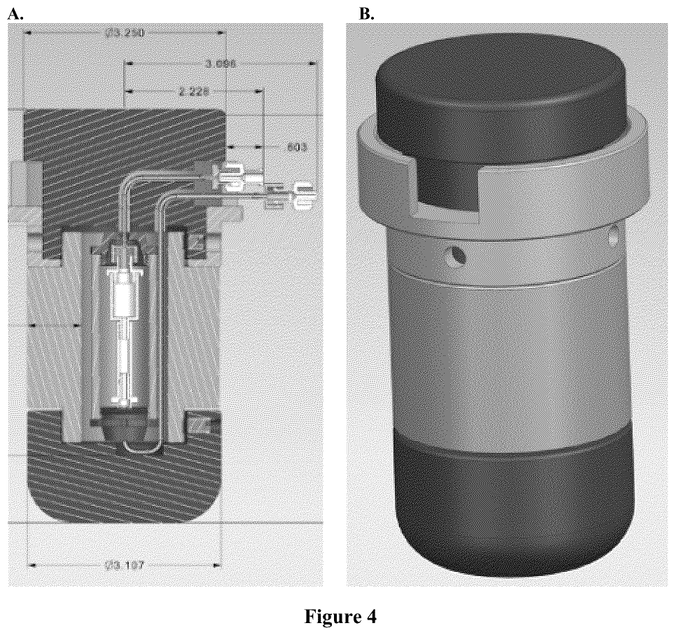

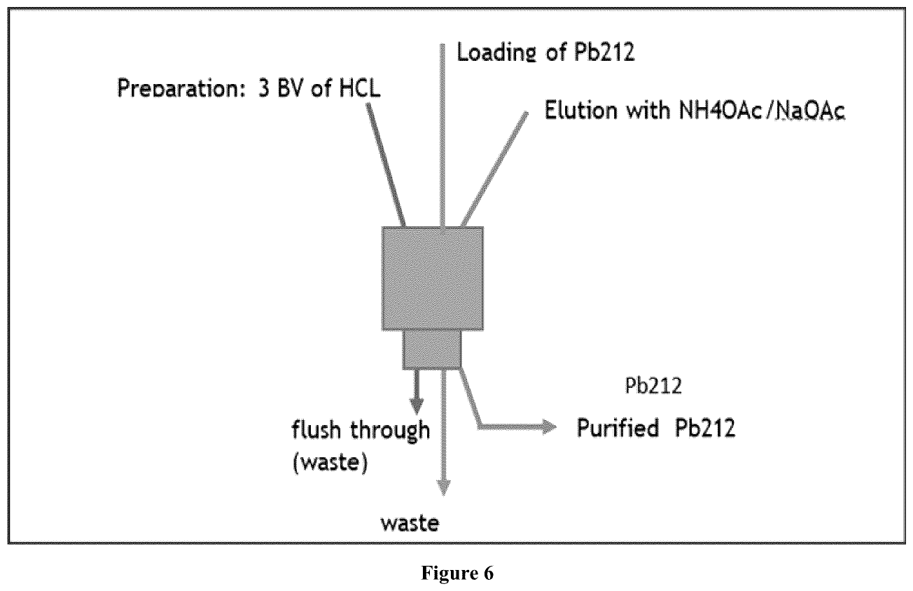

Specific embodiments of the invention are further detailed in FIGS. 1-11. The embodiments in FIGS. 2-3 depict the capability of the invention to comprise multiple columns and allow the simultaneous elution of large amounts of Pb-212 (for example, up to 100 mCi, up to 250 mCi or more, or up to 1 Ci per generator cassette). With the capacity to accommodate multiple generator cassettes, the module enables simultaneous elution of up to 100 mCi Pb-212. All solvents and eluents needed to conduct all aspects of the purification and column regeneration processes of the invention can be attached to the system at the time of installation or as needed. Further, potential routes of user exposure to radiation (e.g., through columns, intermediate and waste vials, and solution carrying lines) can be shielded using the RSA (FIG. 4) and HOUSING CABINET (FIG. 5) units described above and further here within. The following is a detailed description of several embodiments of the present invention. Additional implementations of the present invention will be apparent to persons of ordinary skill in the art.

### Automated Purification Unit

In one embodiment, a purification device as shown in FIGS. 2-3 comprises a multi-port valve system, e.g., 201. In each embodiment the system comprises two multi-port apparatuses (214, 215) organized in parallel with fluid communication between the multi-port valves being achieved by way of HPLC tubing. In one embodiment, the multi-port valve system comprises a total of 12 valves, with each multiport apparatus having 6 valves. In another embodiment, each multiport apparatus may have any integer of valves up to, and including 36 valves. The generator cassettes of FIGS. 2-3 are housed in the RSA 216 (e.g., FIG. 4). For ease of viewing, some figures may not contain or denote 216, but all generator cassettes of all embodiments are housed in RSA 216.

The present disclosure relates to methods and systems for the purification of radioisotopes, particularly Pb-212. The following describes an embodiment for carrying out the purification process. The process utilizes a system comprising a first syringe pump 202, a second syringe pump 203, a source of Hydrochloric acid (HCl) 204, a source of water 205, a source of buffer solution 206, an at least one generator cassette 210 comprising a generator 208 and a catch column 209, a finishing column 211, a waste outlet 213, and a purified product outlet 212. As mentioned above, the at least one generator 208 comprises an at least one chromatography resin with one of them being a cation exchange resin, and the other being, an anion exchange resin. Further, this embodiment's resin for the finishing column is TK201. This automated purification unit 200, is under the control of a control unit 207 which coordinates the timing and execution of each individual step of the purification process. One having ordinary skill in the art will recognize 207 as a computer having the appropriate programing to initiate, execute, and conclude the aforementioned process. The process generally includes steps for conditioning the columns, eluting and loading the sample, rinsing lines, and eluting the final product with fractionation. Back pressure and flow rate are monitored constantly throughout the procedure. While this procedure is written in reference to FIG. 2, these steps are equally applicable to the configuration of FIG. 3, assuming that the volumes provided are scaled in a manner directly proportional to the increased total volume of resin used.

### a) Conditioning Phase

The process begins with a conditioning phase. Initially, the second syringe 203 draws approximately 6.0 mL of 2.0 M HCl 204. Following this, the 6.0 mL of 2.0 M HCl 204 is pushed from the second syringe 203 through the finishing column 211 and directed to the waste 213. This step proceeds at a volume per minute that does not exceed the backpressure tolerated by the resin being used.

### b) Elution Loading Phase

Next, an elution and loading phase is performed. The second syringe 203 again draws approximately 6.0 mL of 2.0 M HCl 204. This volume of 2.0 M HCl 204 is then pushed from the second syringe 203 through the generator 208, the catch column 209, and the finishing column 211, with the effluent directed to the waste 213.

### c) Rinsing

Subsequently, a water flush is performed. The first syringe 202 draws approximately 3.0 mL of water 205. This water is then pushed from the first syringe 202 through the system tubing to the waste 213 to rinse the tubing, also at a rate of about 10.0 mL/min.

The lines are then rinsed with a buffer solution. The first syringe 201 draws approximately 3.0 mL of buffer 205 at a rate of about 10.0 mL/min. This buffer is pushed from the first syringe 201 through the tubing to the waste outlet 209. This step proceeds at a volume per minute that does not exceed the backpressure tolerated by the resin being used.

d) Elution with Fractionation and Purging

The elution process involves fractionation to isolate the pure Pb-212. First, the first syringe 202 draws approximately 0.75 mL of buffer 206. This initial buffer volume is pushed from the first syringe 102 through the finishing column 211 to the waste 213 at a rate of about 10.0 mL/min, with a lower pressure limit of 2 bar for this specific step.

Immediately following this step, the finishing column 211 is purged. The first syringe 202 draws air, which is then pushed through the finishing column 211 to waste 213.

### e) Product Collection and Final Steps

The main product fraction is then collected. The first syringe 202 draws approximately 5 mL of buffer 206. This volume is then pushed from the first syringe 202 through the finishing column 211 and directed to the purified product outlet 212. Finally, the finishing column 211 is rinsed with water. The first syringe 202 draws 5 mL of water 205. This water is then pushed from the first syringe 202 through the finishing column 211 to the waste 213 at a rate of 5.0 mL/min, completing the process.

Another embodiment of the automated purification unit (300, FIG. 3), demonstrates the modularity and ability to scale-up from the embodiment of FIG. 2. One will notice that there are six (6) generator cassettes 310 in a 2×3 configuration disposed between the two multiport valve apparatuses. One will also note the parenthetical text accompanying element 310 which states “n≤6,” where “n” represents the number of generator cassettes. Meaning that there may be up to, and including 6 generator cassettes in this configuration, but not more than 6. Additionally, one will notice that same parenthetical accompanying element 311. As for the finishing column 311, there may be up to and including 6 finishing columns disposed in the loop between valves 8 and 9. One of ordinary skill in the art will appreciate the that the ideal configuration for the inclusion of multiple finishing columns is in series, instead of in parallel, or a mixture of the two. As noted above, the generators 308 will most preferably contain a mixture of cationic and anionic resins at a ratio of anywhere between 99:1 to 1:99. The catch column 309 may consist of MP50 resin, and the finishing column(s) 211 comprises the TK201 resin.

The purification process needed to utilize the embodiment described in FIG. 3 remains the same as that described in the previous embodiment, as it pertains to the process steps. However, a person of ordinary skill in the art will appreciate that as the bed volume of resin increases, the amount of water, buffer, and HCl needed to effectuate the purpose of each step will likewise increase in a directly proportional manner. Accordingly, if deviating from the embodiment disclosed in FIG. 2, one should track the total bed volume of resin utilized, and normalize the volume of HCl, water, and buffer used to the bed volume of resin utilized in the preceding embodiment (2 mL). In one embodiment, all generator cassettes are each contained within a RSA, which may also be contained within a housing cabinet.

In either embodiment, one of ordinary skill in the art will appreciate that the number of valves and multiport valve apparatuses are similarly scalable, and that exact disposition of the HPLC tubing loops are adjustable or variable, so long as the system is able to achieve the purification of Pb-212 as described herein.

### Radiation Shielding Apparatus

An embodiment of a RSA is shown. FIG. 4B shows an external perspective view of the RSA, while FIG. 4A shows a cross-sectional view, illustrating the internal structure and exemplary dimensions in centimeters. However, one skilled in the art will recognize that alternate dimensions may be used while maintaining the purification of Pb-212 described herein. The RSA is designed to house components used in processes involving radioactive materials, such as the generator, catch, or finishing columns previously described. Critically, the RSA serves a dual purpose: it provides substantial radiation shielding to protect users, and it creates a sealed environment around the housed component. This sealed environment is advantageous for preventing contamination, such as shielding the product or process from Rn-220 gas that can be produced during Ra-224 decay.

As shown in FIG. 4, the RSA, in this embodiment, has a generally cylindrical shape. It comprises a main body, which can be constructed in multiple sections, including a lower section, an upper section, and potentially a central connecting or securing band. The main body is designed to contain the radioactive component within a sealed enclosure.

FIG. 4A provides a cross-sectional view, showing a thick outer wall forming the main body, which defines an internal cavity. This internal cavity is configured to receive and hold a component, such as a purification column or a generator, as depicted within the cavity in FIG. 4. The outer wall comprises materials effective in blocking radiation. The generator cassette is placed inside an plastic enclosure which ensure a tight seal when closed. In the embodiment shown in FIG. 4, exemplary dimensions are provided in centimeters, indicating an approximate overall diameter of 3.250 cm, an inner cavity diameter of approximately 2.228 cm, and a lower section diameter of approximately 3.107 cm. It should be understood that these dimensions are exemplary and can be varied based on the specific component to be shielded and the level of shielding required.

The top portion of the RSA, as seen in FIG. 4B, includes features for securing the component and establishing connections while maintaining the integrity of the sealed environment. Connectors and sealed ports are provided, allowing fluidic lines (tubing) to connect to the component housed within. These ports are designed to prevent leakage, ensuring that gases or other potential contaminants do not enter or exit the system uncontrollably.

The radiation shielding material forming the main body can comprise various materials known for their effectiveness in blocking or attenuating radiation. These materials can include lead, depleted uranium, antimony, tungsten, tin, bismuth, cerium, or telluride. Furthermore, polymer composites incorporating these materials may be used, as well as materials like single-walled carbon nanotubes (SWNTs) or boron nitride nanotubes (BNNTs).

The thickness of the radiation shielding wall is selected to ensure that radiation exposure to users is maintained at safe levels. The required thickness will depend on the type and activity of the radioisotope being handled and the specific shielding material chosen. As examples, the shielding can have a thickness ranging from about 0.01 mm up to 9.99 cm or more, covering a wide spectrum of potential needs. For instance, the thickness can range from about 1.00 cm to about 1.99 cm, from about 2.00 cm to about 2.99 cm, or from about 3.00 cm to about 3.99 cm, among other ranges. In still another embodiment, the shielding can have a thickness of about 2.0 cm, 2.1 cm, 2.2 cm, 2.3 cm, 2.4 cm, 2.5 cm, 2.6 cm, 2.7 cm, 2.8 cm, 2.9 cm, or 3.0 cm.

In operation, a radioactive solution containing Ra-224 is passed through the generator cassette which is housed in the sealed enclosure within the internal cavity of the RSA, and the inlet and outlet of the generator are sealed. The whole generator and its shielding thereby functions as a closed system with respect to the immediate surroundings, preventing the exchange of matter (especially gases like Rn-220) while allowing energy (e.g., heat) exchange. The substantial shielding walls effectively block radiation emitted from the component. Simultaneously, the sealed nature contains any gaseous byproducts and protects the internal process from external contaminants. Fluidic access is maintained only through the designated, sealed ports, ensuring controlled operation. Such an apparatus can be applied to individual columns, or multiple columns together.

### Housing Cabinet

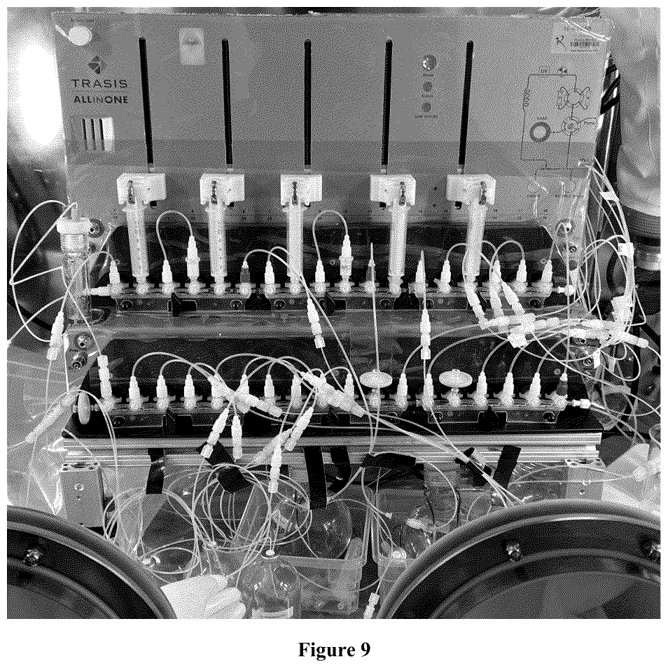

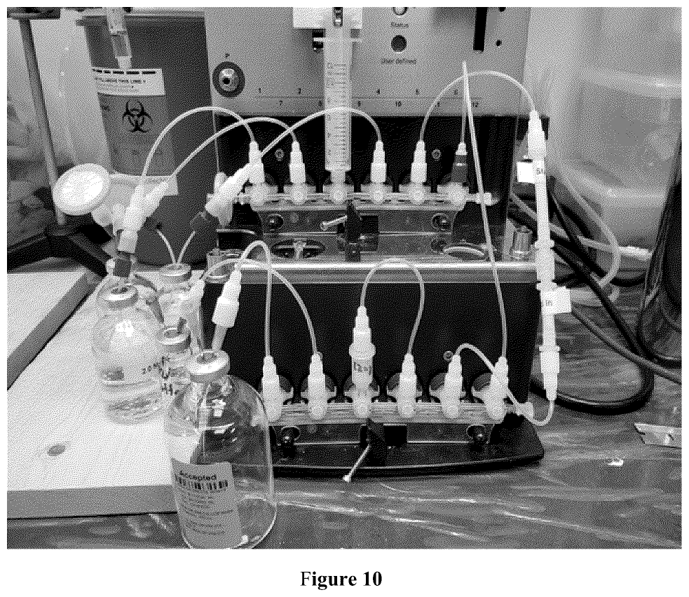

Referring now to FIG. 5, an embodiment of a Housing cabinet is shown. FIG. 5 depicts the housing cabinet in opened and closed configurations, revealing its internal compartments. The housing cabinet 500 is designed to provide a self-contained Pb-212 purification apparatus and system for an entire automated purification unit, like an HPLC system (automated purification device) 501 (for example, the automated purification devices of FIGS. 9 and 10), and one or more Radiation Shielding Apparatuses (RSAs) 502, such as those described previously.

As shown, the housing cabinet comprises a main housing 503, generally having a box-like or cubic shape. In one embodiment, housing cabinet 500 is constructed from a suitable light-weight material. In certain embodiments, the light-weight material is a metal or metal alloy, such as aluminum. In a different embodiment, the housing cabinet 500 is constructed from materials effective in blocking or attenuating radiation, which may include materials such as lead, tungsten, or polymer composites thereof, providing a robust barrier against radiation emitted from the components housed within.

FIG. 5 illustrates the internal structure of the housing cabinet when open. The housing 503 defines at least two distinct internal compartments: a main internal compartment 504 and a secondary internal compartment 505. The main internal compartment 504 is generally the larger volume, sized and configured to house a purification automation system, such as an HPLC system 501. The secondary internal compartment 505, shown in this embodiment adjacent to or within the front section of the main compartment 504, is specifically designed to receive and secure one or more RSAs 502. Within this secondary compartment 505, one or more receptacles 506 are provided. In this embodiment, these receptacles 506 are substantially cylindrical features, shaped and dimensioned to receive and hold the cylindrical RSAs 502.

Access to these compartments is provided via hinged panels. A main hinged lid 507 provides access to the main internal compartment 504. A secondary hinged door 508 provides access to the secondary internal compartment 505. A latching mechanism 509 is provided on the main hinged lid 507 to securely close the cabinet during operation.

The housing 503 may further define various openings or ports 510, as seen on the internal walls in FIG. 5. These ports 510 are strategically placed to allow for the passage of tubing, electrical wiring, and other necessary connections between the components within the housing cabinet 500 and external systems, or between the compartments (504, 505).

In operation, an automated purification device 501 is placed within the main compartment 504, and the RSAs 502 (containing the radioactive sources or columns) are placed within their respective receptacles 506 in the secondary compartment 505. All necessary connections are made through the ports 510. The door 508 and lid 507 are then closed and secured, providing a comprehensive, self-contained environment for the entire automated process.

One skilled in the art will appreciate that the dimensions of the housing cabinet are scalable to accommodate the aforementioned apparatuses within the required internal compartments mentioned above. Minimally, the housing cabinet of FIG. 5 requires dimensions to contain the automated high pressure liquid chromatography system, or automated purification device, 501 selected by the user in main compartment 504. Further, the dimensions of the housing cabinet are minimally able to accommodate the number of RSAs 502 containing the generator cassettes required to purify the necessary amount of Pb-212 desired by the user from a single purification run within the secondary internal compartment 505.

### EXAMPLES

### Example 1: Purification of Th-228 and Ra-224

An automated cassette-based system was used for the purification of Th-228 and Ra-224. This system consisted of AGMP1 and AGMP50 resin used for Th-228 and Ra-224 respectively. FIG. 1 depicts a schematic layout of a sequence used for purification of Th-228 and Ra244. FIG. 9 depicts a device and corresponding flow paths of connections in an automated system embodying the schematic in FIG. 1, for the generation of crude Ra-224 from Th-228, and subsequent purification of the crude Ra-224 to produce purified Ra-224 that is suitable for use in the production of Pb-212.

### Example 2: Specification of Pb-212 Eluted from Ra-224/Pb-212 Generator

Radionuclide analysis of Pb-212 purity was performed using high-resolution ga mm a-ray spectroscopy using an HPGe detector (Canberra) to identify daughter isotopes of Pb-212 (Bi-212, Tl-208) and any potential breakthrough of parent isotopes Ra-224 and Th-228. See Table 1.

TABLE 1
Radionuclide identification of Pb-212

| | | Wt mean | Wt mean | |
|---|---|---|---|---|
| Nuclide | Nuclide Id | Activity | Activity | |
| Name | Confidence | (μCl/units) | Uncertainty | Comments |
| Tl-208 | 0.999 | 2.87E−01 | 2.42E−03 | |
| Bl-212 | 0.781 | 6.47E−01 | 5.98E−03 | |
| PB-212 | 1.000 | 7.75E−01 | 1.05E−02 | |
| Rn-220 | 0.995 | 1.16E+00 | 6.00E−02 | |
| Ra-224 | 1.000 | 1.49E+00 | 3.46E−02 | |
| Th-228 | 0.583 | 1.97E−01 | 7.35E−03 | |

? = nuclide is part of an undetermined solution
X = nuclide rejected by the interference analysis
@ = nuclide contains energy lines not used in Weighted Mean Activity
Errors quoted at 1.000sigma

### Example 3: Chemical Characterization of Pb-212

The chemical purity of Pb-212 eluate was determined using inductively coupled plasma mass spectrometry (ICPMS). A multi-element standard was used to determine content of the most co mm on, stable impurities in Pb-212, which could have a negative effect on the radiolabeling reaction. The trace metal analysis of Pb-212 has shown moderate to low content of Fe, Cu and Ni. Key metals that can affect the radiolabeling yield of labeling with Pb-212 were analyzed (Iron Fe-56, Copper Cu-63, Lead Pb-208, Pb-206 and Pb-207), in addition to others. The content of these metals in the eluate was below 7.7-18 ug/L with the highest value reported for iron. None of these metals had an effect on radiolabeling at the detected levels. The metal content was further reduced in post-purified Pb-212. Table 2 below provides more detailed information on a trace metal analysis of Pb-212 eluted from Ra-224-AMP50 resin according to a process of the invention. The metal content of eluate was monitored over the lifetime of the Ra-224/Pb-212 generator (shown in Table 2), and during a use of the generator (shown in Table 3).

TABLE 2
ICPMS trace metal analysis of Pb-212 eluate
monitored over the lifetime of the generator.

| | | R1: Pb-212 | R2: Pb-212 | R3: Pb-212 |
|---|---|---|---|---|
| | | Eluate | Eluate | Eluate |
| | Element | 100:900 | 100:900 | 100:900 |
| Important | Pb-208 | 0.066 | 0.066 | 0.588 |
| | Pb-206 | 0.042 | 0.042 | 0.311 |
| | Pb-207 | 0.028 | 0.028 | 0.251 |
| | Fe-56 | 1.913 | 1.913 | 7.669 |
| | Cu-63 | 0.087 | 0.087 | 0.61 |
| | Ni-60 | 0 | 0.385 | 0.251 |
| | Al-27 | 40.858 | 235.145 | 232.057 |
| Less | Mg-24 | 0.776 | 2.721 | 2.129 |
| Important | Cr-52 | 0.034 | 0.4 | 0.33 |
| | Mn-55 | 0.042 | 0.351 | 0.243 |
| | Co-59 | 0.006 | 0.084 | 0.083 |
| | Zn-66 | 0.268 | 19.029 | 2.479 |
| | Ga-69 | 0.074 | 0.592 | 0.622 |
| | Nb-93 | 0.008 | 0.009 | 0.012 |
| | Cd-111 | 0.002 | 0.004 | 0.003 |
| | Ba-137 | 0.262 | 2.04 | 2.122 |
| | Ta-181 | 0.004 | 0.002 | 0.002 |
| | Bi-209 | 0.003 | 0.003 | 0.001 |

TABLE 3
ICPMS trace metal analysis of Pb-212 eluates
monitored during a use of the generator

| | | R1: Pb-212 | R2: Pb-212 | R3: Pb-212 | R4: Pb-212 |
|---|---|---|---|---|---|
| | | Eluate | Eluate | Eluate | Eluate |
| | Element | 100:900 | 100:900 | 100:900 | 100:900 |
| Important | Pb-208 | 0.066 | 0.066 | 0.588 | 0.535 |
| | Pb-206 | 0.042 | 0.042 | 0.311 | 0.274 |
| | Pb-207 | 0.028 | 0.028 | 0.251 | 0.229 |
| | Fe-56 | 1.913 | 1.913 | 7.669 | 18.27 |
| | Cu-63 | 0.087 | 0.087 | 0.61 | 0.39 |
| | Ni-60 | 0 | 0.385 | 0.251 | 0.945 |
| | Al-27 | 40.858 | 235.145 | 232.057 | 125.884 |
| Less | Mg-24 | 0.776 | 2.721 | 2.129 | 1.989 |
| Important | Cr-52 | 0.034 | 0.4 | 0.33 | 1.03 |
| | Mn-55 | 0.042 | 0.351 | 0.243 | 0.351 |
| | Co-59 | 0.006 | 0.084 | 0.083 | 0.113 |
| | Zn-66 | 0.268 | 19.029 | 2.479 | 2.246 |
| | Ga-69 | 0.074 | 0.592 | 0.622 | 0.428 |
| | Nb-93 | 0.008 | 0.009 | 0.012 | 0.005 |
| | Cd-111 | 0.002 | 0.004 | 0.003 | 0.002 |
| | Ba-137 | 0.262 | 2.04 | 2.122 | 1.584 |
| | Ta-181 | 0.004 | 0.002 | 0.002 | 0.001 |
| | Bi-209 | 0.003 | 0.003 | 0.001 | 0.002 |

### Example 4: Purification of Pb-212 Using TK201 Resin

### a) Description of TK201 Resin (TrisKem)

TK201 resin (referred to as “TK resin” in this Example 4) comprises a tertiary amine structure and contains a small amount of long-chained alcohols that serve as a radical scavenger and increase the radiolytic stability of the TK resin. The resin acts as a weak ion pair binding agent and allows the elution of isotopes under mild conditions.

### b) Applications of TK201 Resin

The resin can serve for separation of multiple isotopes including Cu isotopes (high selectivity for separation of Cu over Ni, Zn, Ga), technetium, rhenium and lead isotopes (Pb-203, Pb-212).

### c) Protocol for Purification of Pb-212 Using a Manual Approach

TK resin (60 mg/run) was packed manually into a cartridge/column and pre-conditioned with 3 bed volumes (BV) of acid (1M HCl or 2M HCl) prior to elution of the generator. The Pb-212 chloride (2-3 ml in 2M HCl) eluted from generator was loaded on the resin with a flowrate in the order of 0.5-1 BV/min. The activity of the flow through eluate passing through TK resin was determined using the dose calibrator to evaluate the yield of retention of Pb-212. The flow through was then directed to waste. The Pb-212-bound TK resin was washed with 0.5-1 ml ultrapure trace metal free water. Flow through activity was counted on the dose calibrator and collected into a separate vial. The purified Pb-212 was eluted from TK resin using 0.4 M sodium or a mm onium acetate buffer at pH 6.0 directly into a reaction vessel and used for radiolabeling. Purified Pb-212 can be fractioned to reduce the volume in the labeling reaction. The pH of Pb-212 eluted from TK resin was in the optimal range of 5.9-6.1 for the labeling reaction. The TK resin loaded cartridges were regenerated after each run by flushing/pre-conditioning with 2M HCl. The scheme in Table 6 describes the step-by step purification of Pb-212.

### d) Fractionation of Pb-212 Using a Manual Approach

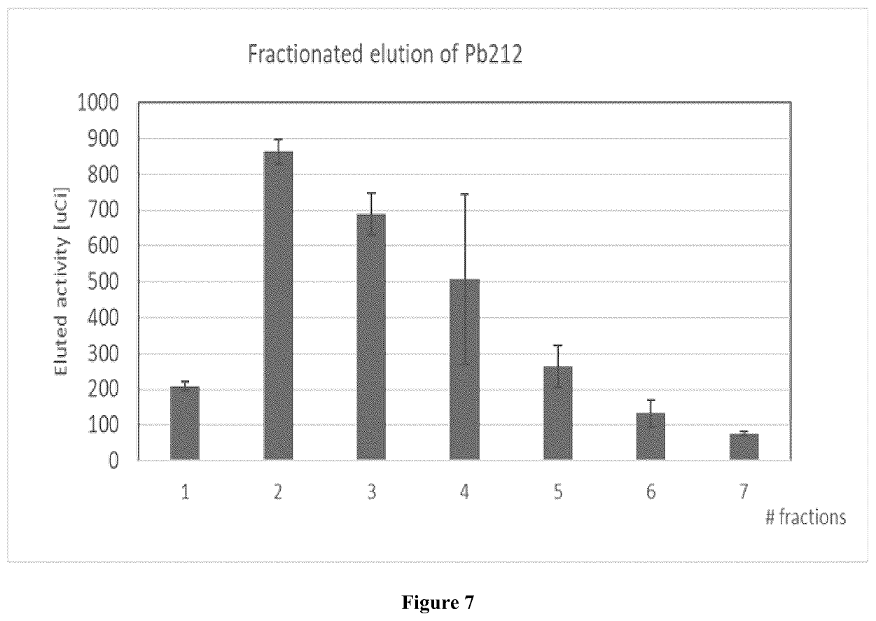

The experiments were performed with 1-8 mCi of Pb-212 purified on TK201 resin. Pb-212 was eluted using 0.4-0.5 M Sodium Acetate buffer at pH=5.8-6.0, or 0.4-0.5M A mm onium Acetate buffer at pH=5.8-6.0. The multiple fractions were collected (100-130 ul/per vial). The activity of each fraction was recorded, and the pH of the eluate was determined. The initial three fractions were discarded, and all following fractions were collected. The collected fractions were used directly for labeling without the need for further adjusting of pH. The highest activity of Pb-212 was observed in collected fractions 1-3 (FIG. 7).

### e) Post-Purification of Pb-212: Radiochemical Yield of Retention and Elution of Pb-212

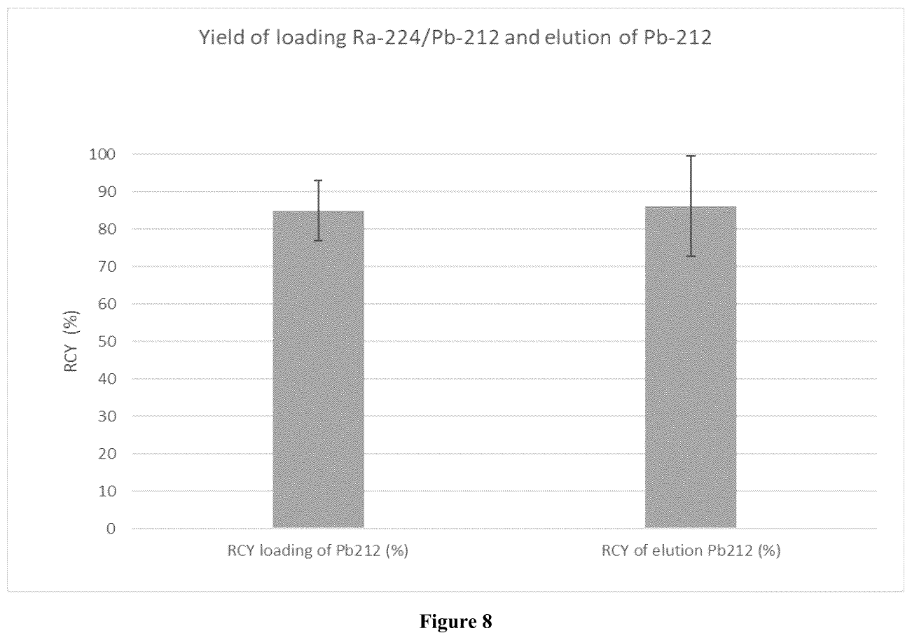

The radiochemical yield of retention (RCY) of Pb-212 on TK resin was 85±8%. The yield of elution of Pb-212 in 0.4-0.5N NaOAc or NH₄OAc buffer pH=6.0 was 86±13%. Table 4 below shows examples of RCY (%) loading and elution of Pb-212 during multiple production runs of Ra-224/Pb-212. The pre-purification column showed consistent retention and recovery of Pb-212 (FIG. 8).

TABLE 4
RCY of retention and elution of Pb-212 from TKI resin

| | | | | | | | AVR RCY % | SDev |
|---|---|---|---|---|---|---|---|---|
| RCY loading ndc [%] | 91.95 | 76.31 | 96.82 | 77.59 | 83.03 | 83.97 | 84.94 | 8.04 |
| RCY elution ndc [%] | 69.97 | 88.54 | 91.35 | 97.42 | 70.03 | 99.58 | 86.15 | 13.13 |

### f) Chemical Characterization of Pb-212

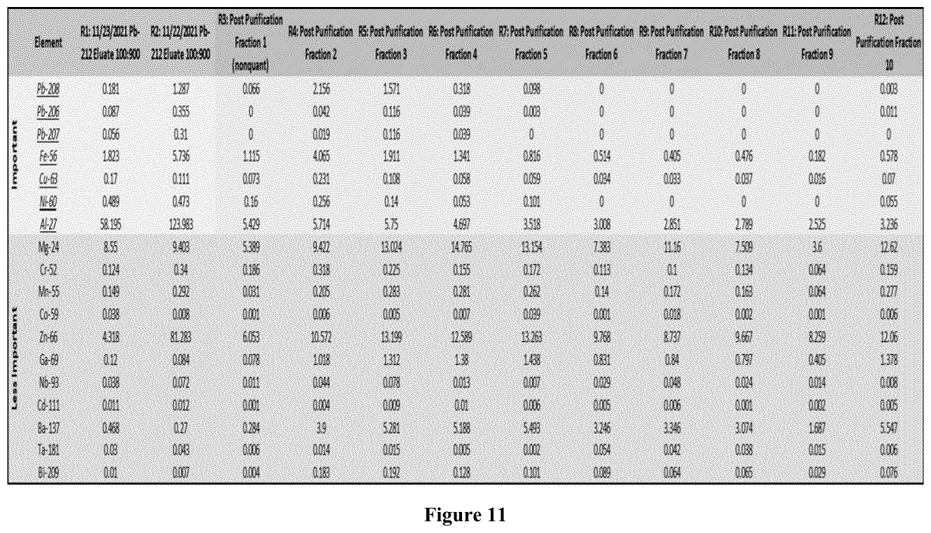

Chemical purity of Pb-212 was determined using inductively coupled plasma mass spectrometry (ICPMS). A multi-element standard was used to determine the content of the co mm on stable impurities in the purified Pb-212 that could have a negative effect on radiolabeling reaction. Fe, Cu, Zn, and Pb were found in low amounts and their content was higher in the first collected fraction. The Table 5 (shown in FIG. 11) below provides a summary of the trace metal analysis of Pb-212 fractions (see FIG. 11, Table 5-ICP-MS trace metal analysis of Pb 212 fractions). Table 5 below summarizes the trace metal analysis of post-purified crude eluate Pb-212. Several fold reductions in the content of the metals tested are seen after post-purification of the crude eluate Pb-212 (for example 1.2-fold reduction in nickel (Ni-60) content and 2281-fold reduction in aluminum (Al-27) content).

TABLE 5
ICP-MS trace metal analysis of Pb-212 eluted from a Ra-224/Pb-212 generator and ICPMS of Pb-212 post-purified fractions.

| | | | | | | | Reduction |
|---|---|---|---|---|---|---|---|
| | | | | | | | of metal |
| | | | | | | | content |
| | | R1: | R2: | R3: No Post | R5: Eluted in | R6: Eluted in | after post- |
| | | Elution | Elution | Purification | 2.0M HCl | 0.4M NaOAc | purification |
| | Element | (ug/L) | (ug/L) | (ug/L) | (ug/L) | Buffer (ug/L) | R3/R6 |
| Impor- | Pb-208 | 2.818 | 4.065 | 1.313 | 0.364 | 0.05 | 26.3 |
| tant | Pb-206 | 1.543 | 0.745 | 0.534 | 0.397 | 0.053 | 10.3 |
| | Pb-207 | 1.419 | 0.578 | 0.463 | 0.365 | 0.061 | 7.6 |
| | Cu-63 | 0.616 | 0.24 | 0.151 | 0.383 | 0.194 | 0.8 |
| | Ni-60 | 7.154 | 0.515 | 0.512 | 0.397 | 0.422 | 1.2 |
| | Al-27 | 624.659 | 505.03 | 310.289 | 157.353 | 0.136 | 2281.5 |
| Less | Mg-24 | 30.692 | 23.552 | 10.925 | 32.22 | 14.321 | 0.8 |
| Impor- | Cr-52 | 13.966 | 1.04 | 0.382 | 0.39 | 1.441 | 0.3 |
| tant | Mn-55 | 3.036 | 1.009 | 0.532 | 1.71 | 1.748 | 0.3 |
| | Co-59 | 0 | 0 | 0 | 0 | 0 | 0.0 |
| | Zn-66 | 318.111 | 373.701 | 190.614 | 539 | 7.601 | 25.1 |
| | Ga-69 | 0.71 | 0.503 | 0.532 | 10.836 | 4.459 | 0.3 |
| | Nb-93 | 0.103 | 0.055 | 0.02 | 0.037 | 0.004 | 5.0 |
| | Cd-111 | 0.01 | 0.012 | 0.005 | 0.008 | 0.002 | 2.5 |
| | Total Pb (ug/L) | 2.24094 | 2.563947672 | 0.9545289 | 0.378715818 | 0.054050256 | |
| | Total Pb (ug) | 0.009177546 | 0.012779484 | 0.001961557 | N/A | N/A | |
| | Specific Activity (mCi/ug) | 182074.8225 | 109550.5858 | 152939.7397 | | | |

### g) Automated Post-Purification of Pb-212

The Pb-212 elution of the generator was done using 2.0 M HCl. Pre-conditioning of TK resin was done prior to elution of the generator. The Pb-212 eluate was loaded on the preconditioned TK201 resin and the flow through was directed to waste. The resin was then neutralized with 0.1-0.5 ml of ultrapure trace metal free water to adjust pH of subsequent fractions of Pb-212. The final purified Pb-212 was eluted on 0.4-0.5 M sodium or a mm onium acetate buffer pH=5.9-6.1 directly to the reaction vessel containing active pharmaceutical ingredient (API) dissolved in buffer pH=6.0. The column was regenerated after each run by flushing with 2 mL of water and 6 CV of 2 M HCl. An exemplary step-by-step description of the Pb-212 post-purification process is provided in Table 6.

TABLE 6
Step-by-step description of post-purification of
Pb-212 using automated approach.

| Step | Description |
|---|---|
| Conditioning | Draw in HCl into syringe 1 |
| Conditioning | Push HCl through finishing resin to waste |
| Elution/ | Draw HCl into syringe I (“HCl #2”) |
| Loading | |
| Elution/ | Push HCl #2 through main, secondary, |
| Loading | and post-purification columns to waste |
| Purge column | Draw air into syringe I |
| Purge column | Push air through main, secondary, |
| | and post purification columns to waste |
| Water flush | Draw water into syringe II |
| Water flush | Push water through post |
| | purification column to waste |
| Elution w/ | Draw buffer into syringe II |
| fractionation | |
| Elution w/ | Push buffer through post |
| fractionation | purification column to waste |
| Elution w/ | Push buffer through post purification |
| fractionation | column to Pure Pb-212 outlet vial |
| Elution w/ | Push buffer through post purification |
| fractionation | column to waste |

### h) Automated Module for Production and Post Purification of Pb-212

RAHA system is a software operated automated module used for reproducible production and purification of high activity of Pb-212. This versatile system can accommodate multiple Ra-224/Pb-212 generators and allows for sequential elution of Pb-212. To reduce radiation exposure, the generator shielding. There are three radiation dose detectors to record differential activity eluted from the generator, loaded on the TK resin, and transferred to a reaction vessel. The RAHA system containing a radiation shielding unit may accommodate different purification automation systems that allow for the efficient and reproducible production and purification of high activity of Pb-212 using Ra-224/Pb-212 generators. As a non-limiting example, a high pressure liquid chromatography system having flow rates and valves sufficient to perform these procedures may be utilized in order to facilitate the purification of Pb-212 from up to 6 Ra-224/Pb-212 generators. It should be noted, as one skilled in the art will appreciate, that the electronic components of the automation systems are internally shielded or separated from the Ra-224/Pb-212 generators to prevent contamination, damage, or interference with those automation electronics by radiation and radioactive decay products.

### Example 5: Ra-224/Pb-212 Generator with Cartridge and Catch Column: Manufacturing and Activity Loading

a) Manufacturing: Assemble Generator Cassette

Table 7 below provides a step-by-step protocol for the manufacture of the generator.

TABLE 7
Step-by-step instruction for the manufacture of the generator.

| Step | Description |
|---|---|
| Step 1 | Put a frit on the bottom of a cartridge |
| Step 2 | Add required amount of resin onto the cartridge |
| Step 3 | Put a frit on the top of the resin |
| Step 4 | Cap the cartridge |
| Step 5 | Attach silicon tube to top of the cartridge |
| | inlet with a suitable fitting. |
| Step 6 | Put a frit on the bottom of a cartridge |

### b) Manufacturing: Assemble Catch Column

Table 8 below provides a step-by-step protocol for the manufacture of the catch column. When the catch column is placed in fluid communication with the generator in a manner such that the catch column is downstream, or is directly receiving the efferent flow of the generator, then the generator cassette as been made.

TABLE 8
Step-by-step instruction for the manufacture of the catch column

| Step | Description |
|---|---|
| Step 1 | Insert frit into Teflon PTA tubing |
| Step 2 | Add required amount of resin into the tubing |
| Step 3 | Put frit on the top of the resin |
| Step 4 | Attach silicon tube to one end of the |
| | column with a suitable fitting. |
| Step 5 | Attach generator cartridge to the other |
| | end of catch column |

c) Activity Loading with Ra-224

Table 9 below provides a step-by-step protocol for loading the generator with Ra-224 preceding its decay and the subsequent purification of Pb-212.

TABLE 9
Step-by-step instructions for the loading of the
generator with Ra-224.

| Step | Description | Rate |
|---|---|---|
| Step 1 | Connect the source Ra-224 solution | — |
| | to an inline pump with a tube | |
| | and PEEK needle. | |
| Step 2 | Connect the inline pump with the | — |
| | generator inlet with a tube. | |
| Step 3 | Connect the generator outlet to a waste vial. | — |
| Step 4 | Start the pump to pass Ra-224 | 4 mL/min |
| | solution through the generator to the | |
| | waste vial. | |
| Step 5 | Optional: Check the waste vial | — |
| | with an HPGe to make sure the | |
| | breakthrough of Ra-224 is | |
| | less than 1%. | |
| Step 6 | Rinse the source Ra-224 vial | 4 mL/min |
| | with 6 mL 2N HCl. | |
| Step 7 | Pass the rinse through the generator | 4 mL/min |
| | to loading the leftover activity | |
| | in the Ra-224 source vial. | |
| Step 8 | Pass 4 mL 2N HCl and 6 mL | 4 mL/min |
| | air through the generator. | |
| Step 9 | Detach the generator inlet and | — |
| | outlet from the inline pump and | |
| | waste tubes. | |
| Step 10 | Attach the end plugs to the inlet | — |
| | and outlet of the generator. | |

### d) Representative Example of Generator Operation

A solution of Ra-224 was loaded directly on the generator with an inline pump. 2M HCl was used to elute Pb-212 from the generator. In a representative run with a generator loaded with 23.4 mCi Ra-224, elution with 6 mL 2N HCl gave 13.8 mCi (2nd day), 10.2 mCi (3rd day), 8.0 mCi (4th day), 6.7 mCi (5th day), 6.1 mCi (6th day), 5.5 mCi (7th day), 4.0 mCi (10th day), 2.2 mCi (11th day), 2.1 mCi (12th day), and 1.6 mCi (13th day). The elution yield typically is above 80% calculated from theoretical Pb-212 generated.

A representative combined operation of generator elution and automated RAHA unit is given below: After elution of the generator with 4 mL 2M HCl, the eluted Pb-212 in 2M HCl was loaded onto a 2 mL cartridge packed with TK201 resin. The TK201 resin was eluted with 0.4N sodium acetate. 0.75 mL eluate was discarded, 3 mL or 5 mL eluate was collected, and the eluted Pb-212 in 0.4N sodium acetate buffer was ready for radiolabeling with drug precursors to form Pb-212 radiolabeled drug products. A typical run with a generator loaded with 21.8 mCi Ra-224 gave 9.1 mCi (2nd day, 69% combined yield generator elution and TK resin purification), 7.4 mCi (3rd day, 68% combined yield generator elution and TK resin purification), 6.5 mCi (4th day, 69% combined yield generator elution and TK resin purification), 5.6 mCi (5th day, 69% combined yield generator elution and TK resin purification), 4.4 mCi (6th day, 69% combined yield generator elution and TK resin purification) and 3.7 mCi (7th day, 69% combined yield generator elution and TK resin purification).

One of skill in the art will appreciate that these numbers are given for a typical run for illustration purposes only, these can be changed or optimized if different size of generator or different amounts of activity is used or needed.

All references cited herein are hereby incorporated by reference. The foregoing is offered primarily for purposes of illustration. It will be readily apparent to those skilled in the art that the invention is not limited to the above embodiments and additional methods and embodiments exist as will be apparent to those skilled in the art, and that the shapes, components, additives, proportions, methods of formulation, processes and other parameters described herein can be modified further or substituted in various ways without departing from the spirit and scope of the invention.

What is claimed is:

1. A device for producing Pb-212, comprising:
a radiation shielding apparatus;
a generator cassette disposed within the radiation shielding apparatus, the generator cassette comprising a generator column containing a resin mixture, wherein the resin mixture is configured to capture Pb-212 and comprises a cationic exchange resin and at least one other chromatography resin;
a purification column comprising a first solid media, wherein the purification column is configured to capture Pb-212 and allow for the subsequent elution of a purified Pb-212 solution therefrom; and
a fluid circuit connecting an outlet of the generator column to an inlet of the purification column, the fluid circuit configured to transport a fluid containing Pb-212 from the generator column to the purification column.

2. The device of claim 1, wherein the at least one other chromatographic resin is an anionic exchange resin.

3. The device of claim 1, wherein the at least one other chromatographic resin is an electrostatically neutral resin.

4. The device of claim 1, wherein the ratio of cation exchange resin to the at least one other chromatographic resin ranges from 1:99 to 99:1.

5. The device of claim 1, wherein the ratio of cation exchange resin to the at least one other chromatographic resin is approximately 1:10 or 10:1.

6. The device of claim 1, wherein the ratio of cation exchange to the at least one other chromatographic resin is approximately 1:1.

7. The device of claim 1, wherein the radiation shielding apparatus comprises an inlet port and an outlet port that are fluidly connected to the fluid circuit.

8. The device of claim 8, further comprising a pump configured to pump fluid through the fluid circuit.

9. The device of claim 1, wherein the generator cassette further comprises a catch column in fluid communication with the generator column and the purification column.

10. The device of claim 1, further comprising a cabinet within which the radiation shielding apparatus is disposed.

11. A method for producing purified Pb-212, the method comprising:
(a) loading a parent radionuclide that generates Pb-212 via radioactive decay onto a generator column of the device of claim 1, wherein the parent radionuclide adsorbs to one or more of the cationic exchange resin, the other chromatography resin, or the resin mixture;
(b) passing a first fluid through the generator column to elute a solution containing the Pb-212;
(c) transferring the solution containing the Pb-212 from the generator column to the purification column;
(d) capturing the Pb-212 from the solution onto the solid media within the purification column; and
(e) passing a second fluid through the purification column to elute a purified Pb-212 solution.

12. The device of claim 11, wherein the at least one other chromatographic resin is an anionic exchange resin.

13. The device of claim 11, wherein the ratio of cation exchange resin to the at least one other chromatographic resin ranges from 1:99 to 99:1.

14. The device of claim 11, wherein the ratio of cation exchange resin to the at least one other chromatographic resin is approximately 1:10 or 10:1.

15. The device of claim 11, wherein the ratio of cation exchange to the at least one other chromatographic resin is approximately 1:1.

16. A device for purifying Ra-224 generated from a first parent radionuclide comprising:
a first solid media comprising a second parent radionuclide and resin, wherein the first parent radionuclide generates Ra-224 by radioactive decay;
a second solid media comprising Ra-224, wherein elution of the Ra-224 from the second solid media produces purified Pb-212 that can be loaded onto a third solid media.

17. A radiation shielding apparatus, comprising:
a. a main body constructed from a radiation-shielding material, said main body having an outer surface and an inner surface, wherein said inner surface defines an internal cavity configured to receive a radioactive component;
b. a closure configured to engage with said main body to form a seal, thereby enclosing said internal cavity to form a sealed environment, said closure defining at least one bore hole extending therethrough;
c. and at least one sealed port disposed at least partially within said at least one bore hole, said sealed port being configured to provide an afferent and an efferent fluidic pathway through said bore hole to said internal cavity while preventing uncontrolled gas exchange between said internal cavity and an exterior environment.

18. The apparatus of claim 17, wherein the radioactive component comprises a device for the production of Pb-212.

19. The apparatus of claim 17, wherein the Pb-212 is produced from a source material selected from the group consisting of Ra-224 and Th-228.

20. The apparatus of claim 17, wherein the device is a liquid chromatography column.

21. The apparatus of claim 20, wherein the liquid chromatography column contains Ra-224 bound to a cationic resin for subsequent purification of Pb-212.

22. The apparatus of claim 17, wherein the radiation-shielding material comprises material selected from the group consisting of lead, depleted uranium, antimony, tungsten, tin, bismuth, cerium, and telluride.

23. The apparatus of claim 17, wherein the radiation-shielding material comprises a polymer composite including at least one material selected from the group consisting of lead, depleted uranium, antimony, tungsten, tin, bismuth, cerium, and telluride.

24. The apparatus of claim 17, wherein the radiation-shielding material comprises tungsten.

25. The apparatus of claim 17, wherein the inner surface defines a generally cylindrical internal cavity.

26. The apparatus of claim 17, wherein the internal cavity includes a bottom surface and an upper opening, said upper opening configured to engage with the closure.

27. The apparatus of claim 17, wherein the bottom surface comprises a raised central pedestal configured to support a base portion of the radioactive component.

28. The apparatus of claim 17, wherein the inner surface comprises at least one internal ledge or step configured to engage or support a portion of the radioactive component.

29. The apparatus of claim 17, wherein the internal cavity is shaped and dimensioned to closely conform to at least a portion of the outer dimensions of the radioactive component.
